(19) United States
(12) Patent Application Publication
(10) Pub. No.: US 2026/0344791 A1
(43) Pub. Date: Nov. 5, 2026

(54) AEROSOL PROVISION SYSTEM

(71) Applicant: Nicoventures Trading Limited, London (GB)

(72) Inventors: Yukun ZHOU, Shenzhen (CN); Phaik EE OOI, Shenzhen (CN)

(21) Appl. No.: 19/485,950

(22) PCT Filed: May 23, 2024
(86) PCT No.: PCT/GB2024/051335

§ 371 Date: Nov. 19, 2025

(30) Foreign Application Priority Data
May 26, 2023 (CN) 202310610498.2
Jun. 9, 2023 (GB) 2308611.9

(51) Int. Cl. A24F 40/57; A24F 40/46; A24F 40/48; A24F 40/51; A24F 40/53; H05B 1/02; H05B 3/02

(52) U.S. Cl. CPC A24F 40/57; A24F 40/46; A24F 40/48; A24F 40/51; A24F 40/53; H05B 1/0202; H05B 3/02

(57) ABSTRACT

An aerosol provision system comprising a heating element for heating aerosol-generating material from a reservoir to generate an aerosol in an aerosol generation region of the aerosol provision system. The aerosol provision system is configured to modify an amount of power which is delivered to the heating element, such to modify the temperature of the aerosol which is generated in the aerosol generation region, depending on a temperature of air surrounding, or passing into, the aerosol provision system, based on an output from a temperature-detecting portion from the aerosol provision system. This thus allows the temperature of the aerosol to be customised/optimised for different ambient temperatures.

### CROSS-REFERENCE TO RELATED APPLICATIONS

This present application is a National Phase entry of PCT Application No.

PCT/GB2024/051335, filed May 23, 2024, which claims priority from Great Britain Application No. 2308611.9, filed Jun. 9, 2023, and which claims priority from Chinese Application NO. 202310610498.2, filed May 26, 2023, each of which are fully incorporated herein by reference in their entireties.

### FIELD

The present disclosure relates to aerosol provision systems such as, but not limited to, nicotine delivery systems (e.g. electronic cigarettes and the like).

### BACKGROUND

Electronic aerosol provision systems often employ an electronic cigarette (e-cigarette) or more generally an aerosol provision device. Such an aerosol provision system typically contains aerosolisable material (also called aerosol-generating material), such as a reservoir of fluid or liquid containing a formulation, typically but not necessarily including nicotine, or a solid material such as a tobacco-based product, from which a vapour/aerosol is generated for inhalation by a user, for example through heat vaporisation. Thus, an aerosol provision system will typically comprise a vaporiser (also called an aerosol generator), e.g. a heating element, arranged to aerosolise a portion of aerosolisable material to generate a vapour.

Once a vapour has been generated, the vapour may be passed through flavouring material to add flavour to the vapour (if the aerosolisable material was not itself flavoured), after which the (flavoured) vapour may be then delivered to a user via a mouthpiece from the aerosol provision system. A potential drawback of existing aerosol provision systems, and associated aerosol provision devices and consumables for use therewith, is that the temperature of the emitted aerosol is not capable of being customised/optimised for different ambient temperatures. In that respect, it has been identified that depending on the ambient temperature surrounding the aerosol provision system (or the aerosol provision device / consumable), it may be preferable to modify the temperature of the emitted aerosol from the aerosol provision system, for example to provide a relatively warmer aerosol in instances where the surrounding ambient temperature is particularly cold.

Various approaches are therefore described herein which seek to help address or mitigate some of these issues, through the implementation of an aerosol provision system which can modify the temperature of its emitted aerosol. For example, this modification may be achieved in some instances through the provision of a temperature-detecting portion, which can generate an output based on the temperature of air surrounding, or passing into, the aerosol provision system, such that this output can be then used to effect a change in the temperature of aerosol which is generated in the aerosol generation region from the aerosol provision system. Equally, such modification may be achieved through providing an aerosol outlet channel which is moveable between a first configuration and a second configuration such that a greater temperature change can be effected in the aerosol, whilst the aerosol passes through the aerosol outlet channel, when the aerosol outlet channel is in the second configuration than when the aerosol outlet channel is in the first configuration. This latter modification may thus allow a user to manually control the temperature of the emitted aerosol, by appropriately adjusting the aerosol outlet channel relative to either of these first or second configurations.

### SUMMARY

According to a first aspect of certain embodiments there is provided an aerosol provision system comprising:
a heating element for heating aerosol-generating material from a reservoir to generate an aerosol in an aerosol generation region of the aerosol provision system;
a temperature-detecting portion which is configured to generate an output based on the temperature of air surrounding, or passing into, the aerosol provision system;
wherein the aerosol provision system is configured to modify an amount of power which is delivered to the heating element, such to modify the temperature of the aerosol which is generated in the aerosol generation region, depending on a temperature of air surrounding, or passing into, the aerosol provision system, based on the output from the temperature-detecting portion;
wherein the aerosol provision system further comprises:
an air inlet channel for delivering air to the heating element;
wherein the temperature of air surrounding, or passing into, the aerosol provision system comprises the temperature of the air in the air inlet channel; and
wherein the air inlet channel comprises an orifice which is configured to deliver air from the air inlet channel to the temperature-detecting portion.

According to a second aspect of certain embodiments there is provided a consumable for an aerosol provision system comprising the consumable and an aerosol provision device configured to receive the consumable, wherein the consumable comprises:
a heating element for heating aerosol-generating material from a reservoir to generate an aerosol in an aerosol generation region of the aerosol provision system;
wherein the aerosol provision device comprises:
a temperature-detecting portion which is configured to generate an output based on the temperature of air surrounding, or passing into, the aerosol provision system;
wherein the aerosol provision system is configured to modify an amount of power which is delivered to the heating element, such to modify the temperature of the aerosol which is generated in the aerosol generation region, depending on a temperature of air surrounding, or passing into, the aerosol provision system, based on the output from the temperature-detecting portion;
wherein the aerosol provision device further comprises:
an air inlet channel for delivering air to the heating element;
wherein the temperature of air surrounding, or passing into, the aerosol provision device comprises the temperature of the air in the air inlet channel; and
wherein the air inlet channel comprises an orifice which is configured to deliver air from the air inlet channel to the temperature-detecting portion.

According to a third aspect of certain embodiments there is provided a method of varying the temperature of an aerosol delivered from an aerosol provision system, the method comprising:
generating an output, from a temperature-detecting portion of the aerosol provision system, which is indicative of a temperature of air surrounding, or passing into, the aerosol provision system; and
the aerosol provision system using the output to determine whether to modify an amount of power which is delivered to the heating element such to modify the temperature of the aerosol which is generated in the aerosol generation region; wherein
air is delivered to the temperature-detecting portion by an air inlet channel for delivering air to the heating element, the temperature of air surrounding, or passing into, the aerosol provision system comprising the temperature of the air in the air inlet channel.

It will be appreciated that features and aspects of the invention described above in relation to the various aspects of the invention are equally applicable to, and may be combined with, embodiments of the invention according to other aspects of the invention as appropriate, and not just in the specific combinations described herein.

### BRIEF DESCRIPTION OF THE DRAWINGS

Embodiments of the invention will now be described, by way of example only, with reference to the accompanying drawings, in which:

FIG. 1 schematically represents in perspective view an aerosol provision system comprising a cartridge and aerosol provision device (shown separated) in accordance with certain embodiments of the disclosure;

FIG. 2 schematically represents in exploded perspective view of components of the cartridge of the aerosol provision system of FIG. 1;

FIGS. 3A to 3C schematically represent various cross-section views of a housing part of the cartridge of the aerosol provision system of FIG. 1;

FIGS. 4A and 4B schematically represent a perspective view and a plan view of a dividing wall element of the cartridge of the aerosol provision system of FIG. 1;

FIGS. 5A to 5C schematically represent two perspective views and a plan view of a resilient plug of the cartridge of the aerosol provision system of FIG. 1;

FIGS. 6A and 6B schematically represent a perspective view and a plan view of a bottom cap of the cartridge of the aerosol provision system of FIG. 1;

FIGS. 7A-7C schematically represent different embodiments of aerosol provision system, employing a temperature-detecting portion, in accordance with certain embodiments of the disclosure.

FIG. 8A schematically represents an embodiment of aerosol provision system, where the aerosol outlet channel is moveable for effecting a temperature change in aerosol passing through the aerosol outlet channel, and where the aerosol outlet channel is in a first configuration, in accordance with certain embodiments of the disclosure.

FIG. 8B schematically represents the embodiment of aerosol provision system from FIG. 8A, where the aerosol outlet channel is in a second configuration, for effecting a different temperature change in aerosol passing through the aerosol outlet channel compared with when the aerosol outlet channel is in the first configuration as per FIG. 8A, in accordance with certain embodiments of the disclosure.

FIG. 8C schematically represents a portion of the embodiment of aerosol provision system from FIGS. 8A and 8B, and which better shows the ability of the aerosol outlet channel to move between the first and second configurations (along with potentially additional intermediary configurations which are between the first and second configurations), in accordance with certain embodiments of the disclosure.

FIG. 9A schematically represents an embodiment of aerosol provision system, where the aerosol outlet channel is moveable for effecting a temperature change in aerosol passing through the aerosol outlet channel, and where the aerosol outlet channel is in a first configuration, in accordance with certain embodiments of the disclosure.

FIG. 9B schematically represents the embodiment of aerosol provision system from FIG. 9A, where the aerosol outlet channel is in a second configuration, for effecting a different temperature change in aerosol passing through the aerosol outlet channel compared with when the aerosol outlet channel is in the first configuration as per FIG. 9A, in accordance with certain embodiments of the disclosure.

FIG. 9C schematically represents a portion of the embodiment of aerosol provision system from FIGS. 9A and 9B, and which better shows the ability of the aerosol outlet channel to move between the first and second configurations (along with potentially additional intermediary configurations which are between the first and second configurations), in accordance with certain embodiments of the disclosure.

FIG. 10A schematically represents an embodiment of aerosol provision system, where the aerosol outlet channel is moveable for effecting a temperature change in aerosol passing through the aerosol outlet channel, and where the aerosol outlet channel is in a first configuration, in accordance with certain embodiments of the disclosure.

FIG. 10B schematically represents the embodiment of aerosol provision system from FIG. 10A, where the aerosol outlet channel is in a second, extended, configuration, for effecting a different temperature change in aerosol passing through the aerosol outlet channel compared with when the aerosol outlet channel is in the first configuration as per FIG. 10A, in accordance with certain embodiments of the disclosure.

FIG. 11 schematically represents an exemplary embodiment of aerosol provision system, useable with any of the embodiments from FIGS. 8A-10B for example, and which shows the aerosol provision system additionally employing an access point, such as a rotatable actuator, for allowing a user to move the aerosol outlet channel between the first and second configurations, in accordance with certain embodiments of the disclosure.

FIG. 12 represents an embodiment of aerosol provision system in accordance with certain embodiments of the disclosure.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to non-combustible aerosol provision systems (such as an e-cigarette). According to the present disclosure, a “non-combustible” aerosol provision system is one where a constituent aerosolisable material of the aerosol provision system (or component thereof) is not combusted or burned in order to facilitate delivery to a user. Aerosolisable material, which also may be referred to herein as aerosol generating material or aerosol precursor material, is material that is capable of generating aerosol, for example when heated, irradiated or energized in any other way. The aerosolisable material may also be flavoured, in some embodiments.

Throughout the following description the term “e-cigarette” or “electronic cigarette” may sometimes be used, but it will be appreciated this term may be used interchangeably with an aerosol provision system. An electronic cigarette may also known as a vaping device or electronic nicotine delivery system (END), although it is noted that the presence of nicotine in the aerosolisable material is not a requirement.

In some embodiments, the aerosol provision system is a hybrid device configured to generate aerosol using a combination of aerosolisable materials, one or a plurality of which may be heated. In some embodiments, the hybrid device comprises a liquid or gel aerosolisable material and a solid aerosolisable material. The solid aerosolisable material may comprise, for example, tobacco or a non-tobacco product.

Typically, the (non-combustible) aerosol provision system may comprise a cartridge/consumable part and a body/reusable/aerosol provision device part, which is configured to releasably engage with the cartridge/consumable part.

The aerosol provision system may be provided with a means for powering a vaporiser therein, and there may be provided an aerosolisable material transport element for receiving the aerosolisable material that is to be vaporised. The aerosol provision system may also be provided with a reservoir for containing aerosolisable material, and in some embodiments a further reservoir for containing flavouring material for flavouring a generated vapour from the aerosol provision system.

In some embodiments, the vaporiser may be a heater/heating element capable of interacting with the aerosolisable material so as to release one or more volatiles from the aerosolisable material to form a vapour/aerosol. In some embodiments, the vaporiser is capable of generating an aerosol from the aerosolisable material without heating. For example, the vaporiser may be capable of generating a vapour/aerosol from the aerosolisable material without applying heat thereto, for example via one or more of vibrational, mechanical, pressurisation or electrostatic means.

In some embodiments, the substance to be delivered may be an aerosolisable material which may comprise an active constituent, a carrier constituent and optionally one or more other functional constituents.

The active constituent may comprise one or more physiologically and/or olfactory active constituents which are included in the aerosolisable material in order to achieve a physiological and/or olfactory response in the user. The active constituent may for example be selected from nutraceuticals, nootropics, and psychoactives. The active constituent may be naturally occurring or synthetically obtained. The active constituent may comprise for example nicotine, caffeine, taurine, theine, a vitamin such as B6 or B12 or C, melatonin, a cannabinoid, or a constituent, derivative, or combinations thereof. The active constituent may comprise a constituent, derivative or extract of tobacco or of another botanical. In some embodiments, the active constituent is a physiologically active constituent and may be selected from nicotine, nicotine salts (e.g. nicotine ditartrate/nicotine bitartrate), nicotine-free tobacco substitutes, other alkaloids such as caffeine, or mixtures thereof.

In some embodiments, the active constituent is an olfactory active constituent and may be selected from a “flavour” and/or “flavourant” which, where local regulations permit, may be used to create a desired taste, aroma or other somatosensorial sensation in a product for adult consumers. In some instances such constituents may be referred to as flavours, flavourants, flavouring material, cooling agents, heating agents, and/or sweetening agents. They may include naturally occurring flavour materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gasone or more of extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamom, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, oil, liquid, or powder.

In some embodiments, the flavouring material (flavour) may comprise menthol, spearmint and/or peppermint. In some embodiments, the flavour comprises flavour components of cucumber, blueberry, citrus fruits and/or redberry. In some embodiments, the flavour comprises eugenol. In some embodiments, the flavour comprises flavour components extracted from tobacco. In some embodiments, the flavour may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucalyptol, WS-3.

The carrier constituent may comprise one or more constituents capable of forming an aerosol. In some embodiments, the carrier constituent may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional constituents may comprise one or more of pH regulators, colouring agents, preservatives, binders, fillers, stabilizers, and/or antioxidants.

As noted above, aerosol provision systems (e-cigarettes) may often comprise a modular assembly including both a reusable part (body—or aerosol provision device) and a replaceable consumable (cartridge) part. Devices conforming to this type of two-part modular configuration may generally be referred to as two-part devices. It is also common for electronic cigarettes to have a generally elongate shape. For the sake of providing a concrete example, certain embodiments of the disclosure described herein may comprise this kind of generally elongate two-part device employing consumable parts. However, it will be appreciated the underlying principles described herein may equally be adopted for other electronic cigarette configurations, for example modular devices comprising more than two parts, as devices conforming to other overall shapes, for example based on so-called box-mod high performance devices that typically have a more boxy shape.

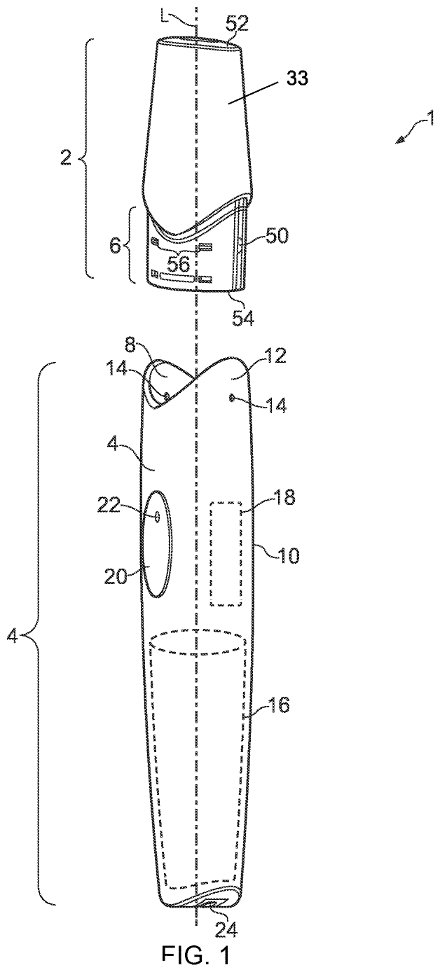

From the forgoing therefore, and with reference to FIG. 1 is a schematic perspective view of an example aerosol provision system (e-cigarette) 1 in accordance with certain embodiments of the disclosure. Terms concerning the relative location of various aspects of the electronic cigarette (e.g. terms such as upper, lower, above, below, top, bottom etc.) are used herein with reference to the orientation of the electronic cigarette as shown in FIG. 1 (unless the context indicates otherwise). However, it will be appreciated this is purely for ease of explanation and is not intended to indicate there is any required orientation for the electronic cigarette in use.

The e-cigarette 1 (aerosol provision system 1) comprises two main components, namely a cartridge 2 and an aerosol provision device 4. The aerosol provision device 4 and the cartridge 2 are shown separated in FIG. 1, but are coupled together when in use.

The cartridge 2 and aerosol provision device 4 are coupled by establishing a mechanical and electrical connection between them. The specific manner in which the mechanical and electrical connection is established is not of primary significance to the principles described herein and may be established in accordance with conventional techniques, for example based around a screw thread, bayonet, latched or friction-fit mechanical fixing with appropriately arranged electrical contacts/electrodes for establishing the electrical connection between the two parts as appropriate. For example electronic cigarette 1 represented in FIG. 1, the cartridge comprises a mouthpiece 33, a mouthpiece end 52 and an interface end 54 and is coupled to the aerosol provision device by inserting an interface end portion 6 at the interface end of the cartridge into a corresponding receptacle 8/receiving section of the aerosol provision device. The interface end portion 6 of the cartridge is a close fit to be receptacle 8 and includes protrusions 56 which engage with corresponding detents in the interior surface of a receptacle wall 12 defining the receptacle 8 to provide a releasable mechanical engagement between the cartridge and the aerosol provision device. An electrical connection is established between the aerosol provision device and the cartridge via a pair of electrical contacts on the bottom of the cartridge (not shown in FIG. 1) and corresponding sprung contact pins in the base of the receptacle 8 (not shown in FIG. 1). As noted above, the specific manner in which the electrical connection is established is not significant to the principles described herein, and indeed some implementations might not have an electrical connection between the cartridge and a aerosol provision device at all, for example because the transfer of electrical power from the reusable part to the cartridge may be wireless (e.g. based on electromagnetic induction techniques).

The electronic cigarette 1 (aerosol provision system) has a generally elongate shape extending along a longitudinal axis L. When the cartridge is coupled to the aerosol provision device, the overall length of the electronic cigarette in this example (along the longitudinal axis) is around 12.5 cm. The overall length of the aerosol provision device is around 9 cm and the overall length of the cartridge is around 5 cm (i.e. there is around 1.5 cm of overlap between the interface end portion 6 of the cartridge and the receptacle 8 of the aerosol provision device when they are coupled together). The electronic cigarette has a cross-section which is generally oval and which is largest around the middle of the electronic cigarette and tapers in a curved manner towards the ends. The cross-section around the middle of the electronic cigarette has a width of around 2.5 cm and a thickness of around 1.7 cm. The end of the cartridge has a width of around 2 cm and a thickness of around 0.6 mm, whereas the other end of the electronic cigarette has a width of around 2 cm and a thickness of around 1.2 cm. The outer housing of the electronic cigarette is in this example is formed from plastic. It will be appreciated the specific size and shape of the electronic cigarette and the material from which it is made is not of primary significance to the principles described herein and may be different in different implementations. That is to say, the principles described herein may equally be adopted for electronic cigarettes having different sizes, shapes and/or materials.

The aerosol provision device 4 may in accordance with certain embodiments of the disclosure be broadly conventional in terms of its functionality and general construction techniques. In the example of FIG. 1, the aerosol provision device 4 comprises a plastic outer housing 10 including the receptacle wall 12 that defines the receptacle 8 for receiving the end of the cartridge as noted above. The outer housing 10 of the aerosol provision device 4 in this example has a generally oval cross section conforming to the shape and size of the cartridge 2 at their interface to provide a smooth transition between the two parts. The receptacle 8 and the end portion 6 of the cartridge 2 are symmetric when rotated through 180° so the cartridge can be inserted into the aerosol provision device in two different orientations. The receptacle wall 12 includes two aerosol provision device air inlet openings 14 (i.e. holes in the wall). These openings 14 are positioned to align with an air inlet 50 for the cartridge when the cartridge is coupled to the aerosol provision device. A different one of the openings 14 aligns with the air inlet 50 of the cartridge in the different orientations. It will be appreciated some implementations may not have any degree of rotational symmetry such that the cartridge is couplable to the aerosol provision device in only one orientation while other implementations may have a higher degree of rotational symmetry such that the cartridge is couplable to the aerosol provision device in more orientations.

The aerosol provision device further comprises a battery 16 for providing operating power for the electronic cigarette, control circuitry 18 for controlling and monitoring the operation of the electronic cigarette, a user input button 20, an indicator light 22, and a charging port 24.

The battery 16 in this example is rechargeable and may be of a conventional type, for example of the kind normally used in electronic cigarettes and other applications requiring provision of relatively high currents over relatively short periods. The battery 16 may be recharged through the charging port 24, which may, for example, comprise a USB connector.

The input button 20 in this example is a conventional mechanical button, for example comprising a sprung mounted component which may be pressed by a user to establish an electrical contact in underlying circuitry. In this regard, the input button may be considered an input device for detecting user input, e.g. to trigger aerosol generation, and the specific manner in which the button is implemented is not significant. For example, other forms of mechanical button or touch-sensitive button (e.g. based on capacitive or optical sensing techniques) may be used in other implementations, or there may be no button and the device may rely on a puff detector for triggering aerosol generation.

The indicator light 22 is provided to give a user with a visual indication of various characteristics associated with the electronic cigarette, for example, an indication of an operating state (e.g. on/off/standby), and other characteristics, such as battery life or fault conditions. Different characteristics may, for example, be indicated through different colours and/or different flash sequences in accordance with generally conventional techniques.

The control circuitry 18 is suitably configured/programmed to control the operation of the electronic cigarette to provide conventional operating functions in line with the established techniques for controlling electronic cigarettes. The control circuitry (processor circuitry) 18 may be considered to logically comprise various sub-units/circuitry elements associated with different aspects of the electronic cigarette's operation. For example, depending on the functionality provided in different implementations, the control circuitry 18 may comprises power supply control circuitry for controlling the supply of power from the battery/power supply to the cartridge in response to user input, user programming circuitry for establishing configuration settings (e.g. user-defined power settings) in response to user input, as well as other functional units/circuitry associated functionality in accordance with the principles described herein and conventional operating aspects of electronic cigarettes, such as indicator light display driving circuitry and user input detection circuitry. It will be appreciated the functionality of the control circuitry 18 can be provided in various different ways, for example using one or more suitably programmed programmable computer(s) and/or one or more suitably configured application-specific integrated circuit(s)/circuitry/chip(s)/chipset(s) configured to provide the desired functionality.

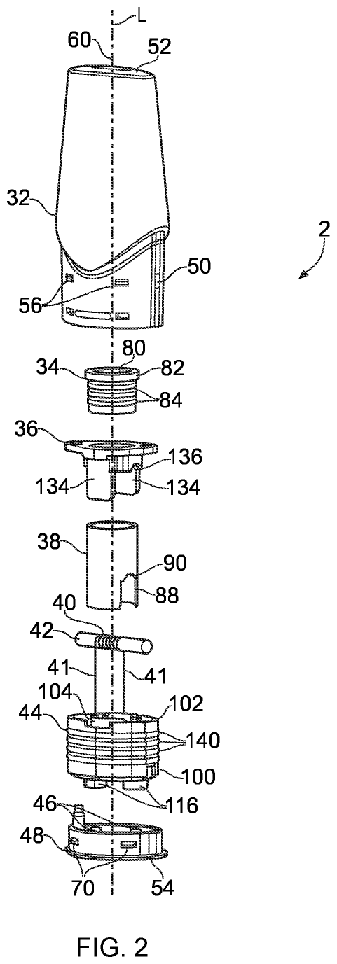

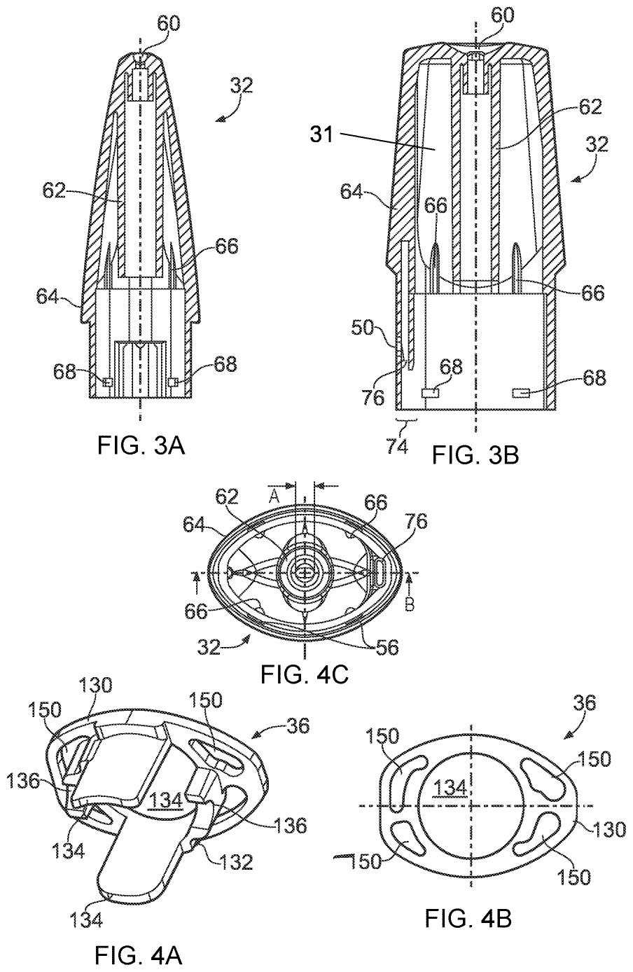

FIG. 2 is an exploded schematic perspective view of the cartridge 2 (exploded along the longitudinal axis L). The cartridge 2 comprises a housing part 32, an air channel seal 34, a dividing wall element 36, an outlet tube 38, a vaporiser/heating element 40, an aerosolisable material transport element 42, a plug 44, and an end cap 48 with contact electrodes 46. FIGS. 3 to 6 schematically represents some of these components in more detail.

FIG. 3A is a schematic cut-away view of the housing part 32 through the longitudinal axis L where the housing part 32 is thinnest. FIG. 3B is a schematic cut-away view of the housing part 32 through the longitudinal axis L where the housing part 32 is widest. FIG. 3C is a schematic view of the housing part along the longitudinal axis L from the interface end 54 (i.e. viewed from below in the orientation of FIGS. 3A and 3B).

FIG. 4A is a schematic perspective view of the dividing wall element 36 as seen from below. FIG. 4B is a schematic cross-section through an upper part of the dividing wall element 36 as viewed from below.

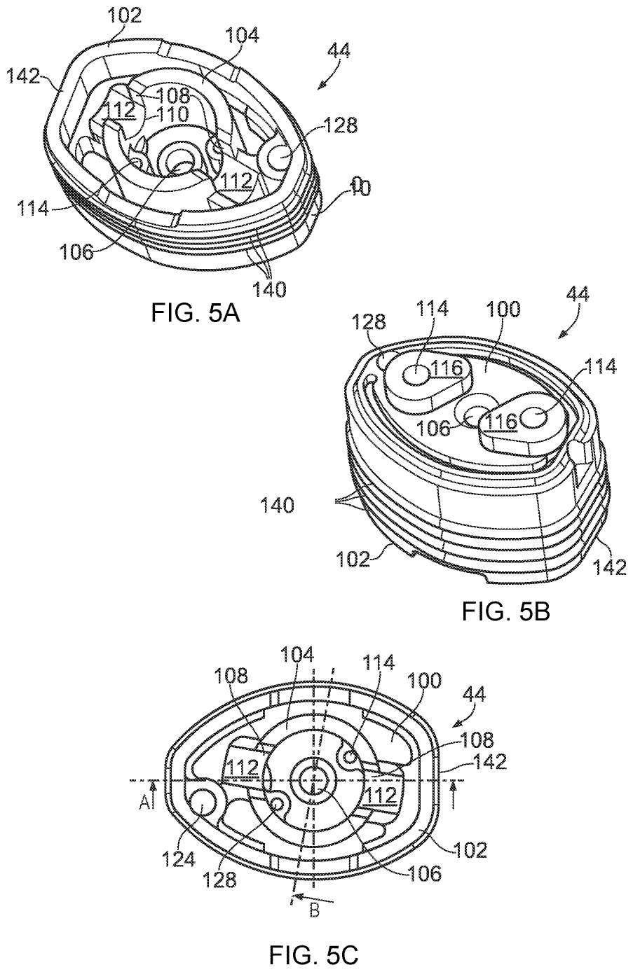

FIG. 5A is a schematic perspective view of the plug 44 from above and FIG. 5B is a schematic perspective view of the plug 44 from below. FIG. 5C is a schematic view of the plug 44 along the longitudinal axis L seen from the mouthpiece end 52 of the cartridge (i.e. viewed from above for the orientation in FIGS. 1 and 2).

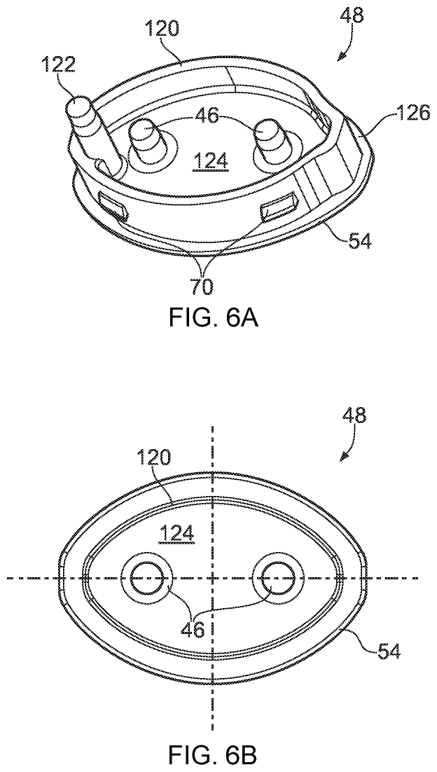

FIG. 6A is a schematic perspective view of the end cap 48 from above. FIG. 6B is a schematic view of the end cap 48 along the longitudinal axis L seen from the mouthpiece end 52 of the cartridge (i.e. from above).

The housing part 32 in this example comprises a housing outer wall 64 and a housing inner tube 62 which in this example are formed from a single moulding of polypropylene. The housing outer wall 64 defines the external appearance of the cartridge 2 and the housing inner tube 62 defines a part the air channel through the cartridge. The housing part is open at the interface end 54 of the cartridge and closed at the mouthpiece end 52 of the cartridge except for a mouthpiece opening/aerosol outlet 60, from the mouthpiece 33, which is in fluid communication with the housing inner tube 62. The housing part 32 includes an opening in a sidewall which provides the air inlet 50 for the cartridge. The air inlet 50 in this example has an area of around 2 mm². The outer surface of the outer wall 64 of the housing part 32 includes the protrusions 56 discussed above which engage with corresponding detents in the interior surface of the receptacle wall 12 defining the receptacle 8 to provide a releasable mechanical engagement between the cartridge and the aerosol provision device. The inner surface of the outer wall 64 of the housing part includes further protrusions 66 which act to provide an abutment stop for locating the dividing wall element 36 along the longitudinal axis L when the cartridge is assembled. The outer wall 64 of the housing part 32 further comprises holes which provide latch recesses 68 arranged to receive corresponding latch projections 70 in the end cap to fix the end cap to be housing part when the cartridge is assembled.

The outer wall 64 of the housing part 32 includes a double-walled section 74 that defines a gap 76 in fluid communication with the air inlet 50. The gap 76 provides a portion of the air channel through the cartridge. In this example the doubled-walled section 74 of the housing part 32 is arranged so the gap defines an air channel running within the housing outer wall 64 parallel to the longitudinal axis with a cross-section in a plane perpendicular to the longitudinal axis of around 3 mm². The gap/portion of air channel 76 defined by the double-walled section of the housing part extends down to the open end of the housing part 32.

The air channel seal 34 is a silicone moulding generally in the form of a tube having a through hole 80. The outer wall of the air channel seal 34 includes circumferential ridges 84 and an upper collar 82. The inner wall of the air channel seal 34 also includes circumferential ridges, but these are not visible in FIG. 2. When the cartridge is assembled the air channel seal 34 is mounted to the housing inner tube 62 with an end of the housing inner tube 62 extending partly into the through hole 80 of the air channel seal 34. The through hole 80 in the air channel seal has a diameter of around 5.8 mm in its relaxed state whereas the end of the housing inner tube 62 has a diameter of around 6.2 mm so that a seal is formed when the air channel seal 34 is stretched to accommodate the housing inner tube 62. This seal is facilitated by the ridges on the inner surface of the air channel seal 34.

The outlet tube 38 comprises a tubular section, for instance made of ANSI 304 stainless steel or polypropylene, with an internal diameter of around 8.6 mm and a wall thickness of around 0.2 mm. The bottom end of the outlet tube 38 includes a pair of diametrically opposing slots 88 with an end of each slot having a semi-circular recess 90. When the cartridge is assembled the outlet tube 38 mounts to the outer surface of the air channel seal 34. The outer diameter of the air channel seal is around 9.0 mm in its relaxed state so that a seal is formed when the air channel seal 34 is compressed to fit inside the outlet tube 38. This seal is facilitated by the ridges 84 on the outer surface of the air channel seal 34. The collar 80 on the air channel seal 34 provides a stop for the outlet tube 38.

The aerosolisable material transport element 42 comprises a capillary wick and the vaporiser (aerosol generator) 40 comprises a resistance wire heater wound around the capillary wick. In addition to the portion of the resistance wire wound around the capillary wick, the vaporiser comprises electrical leads 41 which pass through holes in the plug 44 to contact electrodes 46 mounted to the end cap 54 to allow power to be supplied to the vaporiser via the electrical interface the established when the cartridge is connected to an aerosol provision device. The vaporiser leads 41 may comprise the same material as the resistance wire wound around the capillary wick, or may comprise a different material (e.g. lower-resistance material) connected to the resistance wire wound around the capillary wick. In this example the heater coil 40 comprises a nickel iron alloy wire and the wick 42 comprises a glass fibre bundle. The vaporiser and aerosolisable material transport element may be provided in accordance with any conventional techniques and it may comprise different forms and/or different materials. For example, in some implementations the wick may comprise fibrous or solid a ceramic material and the heater may comprise a different alloy. In other examples the heater and wick may be combined, for example in the form of a porous and a resistive material. More generally, it will be appreciated the specific nature aerosolisable material transport element and vaporiser is not of primary significance to the principles described herein.

When the cartridge is assembled, the wick 42 is received in the semi-circular recesses 90 of the outlet tube 38 so that a central portion of the wick about which the heating coil is would is inside the outlet tube while end portions of the wick are outside the outlet tube 38.

The plug 44 in this example comprises a single moulding of silicone, may be resilient. The plug comprises a base part 100 with an outer wall 102 extending upwardly therefrom (i.e. towards the mouthpiece end of the cartridge). The plug further comprises an inner wall 104 extending upwardly from the base part 100 and surrounding a through hole 106 through the base part 100.

The outer wall 102 of the plug 44 conforms to an inner surface of the housing part 32 so that when the cartridge is assembled the plug in 44 forms a seal with the housing part 32. The inner wall 104 of the plug 44 conforms to an inner surface of the outlet tube 38 so that when the cartridge is assembled the plug 44 also forms a seal with the outlet tube 38. The inner wall 104 includes a pair of diametrically opposing slots 108 with the end of each slot having a semi-circular recess 110. Extended outwardly (i.e. in a direction away from the longitudinal axis of the cartridge) from the bottom of each slot in the inner wall 104 is a cradle section 112 shaped to receive a section of the aerosolisable material transport element 42 when the cartridge is assembled. The slots 108 and semi-circular recesses 110 provided by the inner wall of the plug 44 and the slots 88 and semi-circular recesses 90 of the outlet tube 38 are aligned so that the slots 88 in the outlet tube 38 accommodate respective ones of the cradles 112 with the respective semi-circular recesses in the outlet tube and plug cooperating to define holes through which the aerosolisable material transport element passes. The size of the holes provided by the semi-circular recesses through which the aerosolisable material transport element passes correspond closely to the size and shape of the aerosolisable material transport element, but are slightly smaller so a degree of compression is provided by the resilience of the plug 44. This allows aerosolisable material to be transported along the aerosolisable material transport element by capillary action while restricting the extent to which aerosolisable material which is not transported by capillary action can pass through the openings. As noted above, the plug 44 includes further openings 114 in the base part 100 through which the contact leads 41 for the vaporiser pass when the cartridge is assembled. The bottom of the base part of the plug includes spacers 116 which maintain an offset between the remaining surface of the bottom of the base part and the end cap 48. These spacers 116 include the openings 114 through which the electrical contact leads 41 for the vaporiser pass.

The end cap 48 comprises a polypropylene moulding with a pair of gold-plated copper electrode posts 46 mounted therein.

The ends of the electrode posts 44 on the bottom side of the end cap are close to flush with the interface end 54 of the cartridge provided by the end cap 48. These are the parts of the electrodes to which correspondingly aligned sprung contacts in the aerosol provision device 4 connect when the cartridge 2 is assembled and connected to the aerosol provision device 4. The ends of the electrode posts on the inside of the cartridge extend away from the end cap 48 and into the holes 114 in the plug 44 through which the contact leads 41 pass. The electrode posts are slightly oversized relative to the holes 114 and include a chamfer at their upper ends to facilitate insertion into the holes 114 in the plug where they are maintained in pressed contact with the contact leads for the vaporiser by virtue of the plug.

The end cap has a base section 124 and an upstanding wall 120 which conforms to the inner surface of the housing part 32. The upstanding wall 120 of the end cap 48 is inserted into the housing part 32 so the latch projections 70 engage with the latch recesses 68 in the housing part 32 to snap-fit the end cap 48 to the housing part when the cartridge is assembled. The top of the upstanding wall 120 of the end cap 48 abuts a peripheral part of the plug 44 and the lower face of the spacers 116 on the plug also abut the base section 124 of the plug so that when the end cap 48 is attached to the housing part it presses against the resilient part 44 to maintain it in slight compression.

The base portion 124 of the end cap 48 includes a peripheral lip 126 beyond the base of the upstanding wall 112 with a thickness which corresponds with the thickness of the outer wall of the housing part at the interface end of the cartridge. The end cap also includes an upstanding locating pin 122 which aligns with a corresponding locating hole 128 in the plug to help establish their relative location during assembly.

The dividing wall element 36 comprises a single moulding of polypropylene and includes a dividing wall 130 and a collar 132 formed by projections from the dividing wall 130 in the direction towards the interface end of the cartridge. The dividing wall element 36 has a central opening 134 through which the outlet tube 38 passes (i.e. the dividing wall is arranged around the outlet tube 38). In some embodiments, the dividing wall element 36 may be integrally formed with the outlet tube 38. When the cartridge is assembled, the upper surface of the outer wall 102 of the plug 44 engages with the lower surface of the dividing wall 130, and the upper surface of the dividing wall 130 in turn engages with the projections 66 on the inner surface of the outer wall 64 of the housing part 32. Thus, the dividing wall 130 prevents the plug from being pushed too far into the housing part 32—i.e. the dividing wall 130 is fixedly located along the longitudinal axis of the cartridge by the protrusions 66 in the housing part and so provides the plug with a fixed surface to push against. The collar 132 formed by projections from the dividing wall includes a first pair of opposing projections/tongues 134 which engage with corresponding recesses on an inner surface of the outer wall 102 of the plug 44. The protrusions from the dividing wall 130 further provide a pair of cradle sections 136 configured to engage with corresponding ones of the cradle sections 112 in the part 44 when the cartridge is assembled to further define the opening through which the aerosolisable material transport element passes.

When the cartridge 2 is assembled an air channel extending from the air inlet 50 to the aerosol outlet 60 through the cartridge is formed. Starting from the air inlet 50 in the side wall of the housing part 32, a first section of the air channel is provided by the gap 76 formed by the double-walled section 74 in the outer wall 64 of the housing part 32 and extends from the air inlet 50 towards the interface end 54 of the cartridge and past the plug 44. A second portion of the air channel is provided by the gap between the base of the plug 44 and the end cap 48. A third portion of the air channel is provided by the hole 106 through the plug 44. A fourth portion of the air channel is provided by the region within the inner wall 104 of the plug and the outlet tube around the vaporiser 40. This fourth portion of the air channel may also be referred to as an aerosol/aerosol generation region, it being the primary region in which aerosol is generated during use. The air channel from the air inlet 50 to the aerosol generation region may be referred to as an air inlet section of the air channel. A fifth portion of the air channel is provided by the remainder of the outlet tube 38. A sixth portion of the air channel is provided by the outer housing inner tube 62 which connects the air channel to the aerosol outlet 60, which is located at an end of the mouthpiece 33. The air channel from the aerosol generation region to be the aerosol outlet may be referred to as an aerosol outlet section of the air channel.

Also, when the cartridge is assembled a reservoir 31 for aerosolisable material is formed by the space outside the air channel and inside the housing part 32. This may be filled during manufacture, for example through a filling hole which is then sealed, or by other means. The specific nature of the aerosolisable material, for example in terms of its composition, is not of primary significance to the principles described herein, and in general any conventional aerosolisable material of the type normally used in electronic cigarettes may be used. The present disclosure may refer to a liquid as the aerosolisable material, which as mentioned above may be a conventional e-liquid. However, the principles of the present disclosure apply to any aerosolisable material which has the ability to flow, and may include a liquid, a gel, or a solid, where for a solid a plurality of solid particles may be considered to have the ability to flow when considered as a bulk.

The reservoir is closed at the interface end of the cartridge by the plug 44. The reservoir includes a first region above the dividing wall 130 and a second region below the dividing wall 130 within the space formed between the air channel and the outer wall of the plug. The aerosolisable material transport element (capillary wick) 42 passes through openings in the wall of the air channel provided by the semi-circular recesses 108, 90 in the plug 44 and the outlet tube 38 and the cradle sections 112, 136 in the plug 44 and the dividing wall element 36 that engage with one another as discussed above. Thus, the ends of the aerosolisable material transport element extend into the second region of the reservoir from which they draw aerosolisable material through the openings in the air channel to the vaporiser 40 for subsequent vaporisation.

In normal use, the cartridge 2 is coupled to the aerosol provision device 4 and the aerosol provision device activated to supply power to the cartridge via the contact electrodes 46 in the end cap 48. Power then passes through the connection leads 41 to the vaporiser 40. The vaporiser is thus electrically heated and so vaporises a portion of the aerosolisable material from the aerosolisable material transport element in the vicinity of the vaporiser.

This generates aerosol in the aerosol generation region of the air path. Aerosolisable material that is vaporised from the aerosolisable material transport element is replaced by more aerosolisable material drawn from the reservoir by capillary action. While the vaporiser is activated, a user inhales on the mouthpiece end 52 of the cartridge. This causes air to be drawn through whichever aerosol provision device air inlet 14 aligns with the air inlet 50 of the cartridge (which will depend on the orientation in which the cartridge was inserted into the aerosol provision device receptacle 8). Air then enters the cartridge through the air inlet 50, passes along the gap 76 in the double-walled section 74 of the housing part 32, passes between the plug 44 and the end cap 48 before entering the aerosol generation region surrounding the vaporiser 40 through the hole 106 in the base part 100 of the plug 44. The incoming air mixes with aerosol generated from the vaporiser to form a condensation aerosol, which is then drawn along the outlet tube 38 and the housing part inner 62 before exiting through the mouthpiece outlet/aerosol outlet 60 for user inhalation.

From the above FIGS. 1-6B, it can be seen a possible embodiment construction of aerosol provision system 1 which is configured for generating an aerosol, which is suitable for use in the context of the present disclosure (alongside potentially other forms of aerosol provision system).

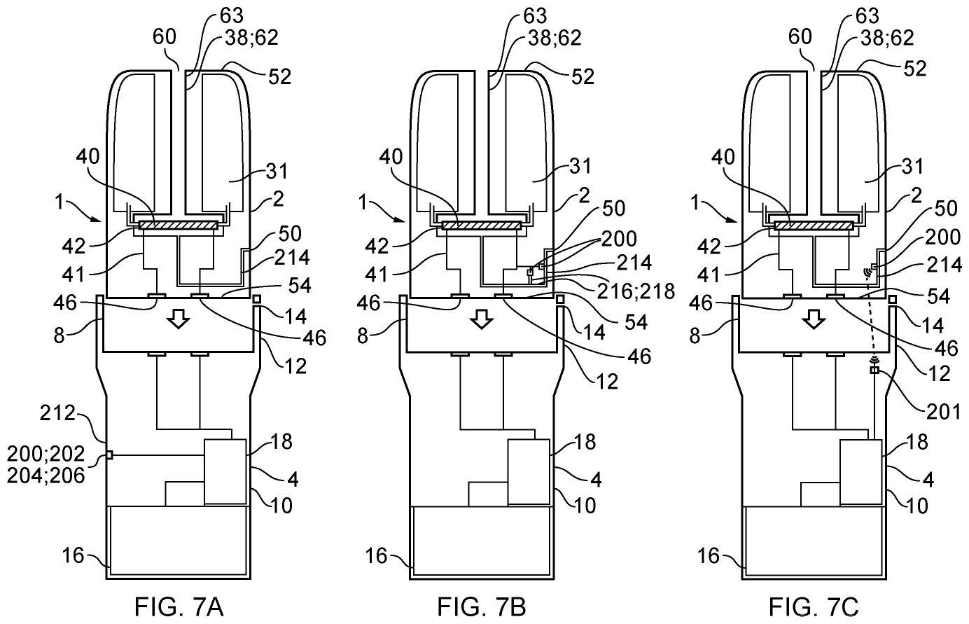

Turning now to FIGS. 7A-7C, the present disclosure also provides for an aerosol provision system 1 which, at a very general level, is configured to modify an amount of power which is delivered to its heating element 40 (such as the heating element 40 shown in the embodiments from FIGS. 1-6B), such to modify the temperature of the aerosol which is generated in the aerosol generation region of the aerosol provision system 1, depending on a temperature of air surrounding, or passing into, the aerosol provision system 1. In this way, and as described above, this may allow for the generated aerosol to be customised/optimised to cater for different ambient temperatures (e.g. providing a relatively warmer aerosol in the case of a relatively cooler ambient set of conditions).

Mindful of the above therefore, the aerosol provision system 1 may be provided with a temperature-detecting portion 200 which is configured to generate an output based on the temperature of air surrounding, or passing into, the aerosol provision system 1. Such a temperature-detecting portion 200 is shown in the embodiments of FIGS. 7A-7C.

The purpose of the temperature-detecting portion 200 is such that the aerosol provision system 1 may be configured to modify an amount of power which is delivered to the heating element 40, such to modify the temperature of the aerosol which is generated in the aerosol generation region, depending on a temperature of air surrounding, or passing into, the aerosol provision system, based on the output from the temperature-detecting portion 200. So for example, in one embodiment where it is detected that the ambient temperature is relatively cold, this may be then detected by the temperature-detecting portion 200 for allowing the aerosol provision system 1 to then increase the amount of power which is delivered to the heating element 40, such to retain the desired/optimised temperature of aerosol which reaches the user's mouth—in spite of these cold conditions. Conversely, in another embodiment where it is detected that the ambient temperature is relatively hot, this may be then detected by the temperature-detecting portion 200 for allowing the aerosol provision system 1 to then potentially decrease the amount of power which is delivered to the heating element 40, such to retain the desired/optimised temperature of aerosol which reaches the user's mouth—in spite of these relatively hotter conditions. It may be thus seen that the provision of this temperature-detecting portion 200 can provide for a more optimised aerosol delivery which can compensate for differing ambient temperatures in/around the aerosol provision system 1.

As to the nature of the temperature-detecting portion 200, it will be appreciated that this could take a number of different forms, as required. For example, in some embodiments, the temperature-detecting portion 200 might comprise a temperature sensor 202 for outputting sensor data indicative of the temperature of air surrounding, or passing into, the aerosol provision system 1, wherein the output comprises the sensor data.

Equally however, in some embodiments, it is envisaged that the temperature-detecting portion 202 might comprise a temperature dependent switch 204 (which might then trigger at a predetermined/threshold temperature level), or even a thermistor 206. The important property of the temperature-detecting portion 200 however is that it can act as a means/mechanism for detecting the temperature of air surrounding, or passing into, the aerosol provision system 1.

In terms of the location for any provided temperature-detecting portion 200, it will be appreciated that it may be located in a number of different locations, as required, to allow it to effectively detect the temperature of air surrounding, or passing into, the aerosol provision system 1. For example, in some embodiments such as that shown in the embodiment of FIG. 7A, where the aerosol provision system 1 comprise an outer housing, the temperature-detecting portion 200 may be located within (at least partially or completely) within the outer housing to help protect the temperature-detecting portion 200 from inadvertent damage whilst in use. To be clear, such an outer housing may be an outer housing from the aerosol provision device 2, or the consumable 4, where the aerosol provision system 1 employs such a two-part aerosol provision device 2/consumable 4 assembly. In this respect as well, where such a two-part aerosol provision device 2/consumable 4 arrangement is employed for the aerosol provision system 1, it may be appreciated that any employed temperature-detecting portion 200 may be located as part of either the aerosol provision device 2 (as shown in the embodiment of FIG. 7A), or as part of the consumable 4 (as shown in the embodiments of FIGS. 7B and 7C). Irrespective of where the temperature-detecting portion 200 is exactly employed however, it may be seen that in some embodiments, the temperature-detecting portion 200 in accordance with some embodiments (such as that shown in the embodiment of FIG. 7A) may be located on, and/or exposed at, an external surface 212 of the aerosol provision system 1. Such arrangements may thus be particularly suited for where the temperature-detecting portion is configured to detect the temperature of air surrounding the aerosol provision system 1.

Appreciably however, in some additional/alternative embodiments, the temperature-detecting portion 200 may be configured to detect the temperature of air passing into the aerosol provision system 1, by way of detecting the temperature air in an air inlet channel 214 which is configured for delivering air to the heating element 40. This air inlet channel as shown in the embodiments from the Figures may the air inlet channel 214 which receives air form the air inlet 50, or in other words the air inlet channel which is upstream of the heating element 40/aerosol generation region, and which is downstream of the air inlet 50. In accordance with some of these embodiments, the temperature-detecting portion 200 may be exposed to the air inside the air inlet channel 214 (as shown in the embodiments of FIGS. 7B and 7C, for example), and/or may in some embodiments may be located in the air inlet channel 214. In some potential related embodiments too, for better preventing any employed temperature-detecting portion 200 from partially blocking/obstructing the air inlet channel 214, it will be appreciated that in some embodiments, the air inlet channel 214 may comprise an orifice 216 which is configured to deliver air from the air inlet channel 214 to the temperature-detecting portion 200. Such an orifice 216, for example, could be located upstream of the heating element 40/aerosol generation region, and/or downstream of the air inlet 50. In this way, the orifice 216 may effectively allow a portion of the air from the air inlet channel 214 to pass into a passage 218 which is in fluid communication with the temperature-detecting portion 200. Such a potential position for the temperature-detecting portion 200 is shown in one of the potential positions for the temperature-detecting portion 200 as shown in the embodiment from FIG. 7B.

Turning to the function of any employed temperature-detecting portion 200, it will be appreciated in some embodiments that the output from the temperature-detecting portion 200 might in some instances have a direct output/ability to effect the power delivered to the heating element 40 for effecting the variation in the power delivered to the heating element 40. For example, where the temperature-detecting portion 200 comprises a thermistor, where the resistance of the thermistor decreases as the surrounding temperature increases, it may be appreciated that such a thermistor may be located in a heat sensor circuit whereby as the resistance of the thermistor decreases (indicative of increasing ambient temperatures), the power delivered to the heating element which is also part of this heat sensor circuit then decreases (to ensure a cooler delivered aerosol to the user). In accordance with some embodiments however, the aerosol provision system 1 may be provided with control circuitry (such as potentially the control circuitry 18 shown in the embodiments from the Figures) which is configured to receive the output from the temperature-detecting portion 200, and which is configured to process the output to determine whether to modify the amount of power which is delivered to the heating element 40 such to modify the temperature of the aerosol which is generated in the aerosol generation region. For example, in one particular embodiment, the control circuitry 18 being configured to process the output to determine whether to modify the amount of power which is delivered to the heating element 40 may further comprise the control circuitry 18 being configured to determine whether the output is indicative of a temperature which is less than, or equal to, a predetermined temperature. In this way, the control circuitry 18 may then be configured to provide a first amount power which is delivered to the heating element 40 in response to determining that the output is indicative of a temperature which is less than, or equal to, the predetermined temperature; and be configured to provide a second amount power, which is less than the first amount of power, which is delivered to the heating element 40 in response to determining that the output is indicative of a temperature which is greater than the predetermined temperature. In accordance with this latter embodiment therefore, it may be seen that the aerosol provision system 1/temperature-detecting portion 200 may be configured to vary the amount of power varied to the heating element 40 at a threshold/predetermined temperature. As to what this threshold/predetermined temperature might be, this in some embodiments may be equal to, or no greater than, any of 20° C.; 15° C., or 10° C. Thus these temperature values may be indicative of a threshold/predetermined temperature below which are indicative of too-cold conditions, which might have a detrimental effect on the ability of the aerosol provision system 1 to otherwise provide an aerosol with the desired temperature/properties without additional power being provided to the heating element 40.

To the extent in such embodiments where a differing first/second amounts of power may be delivered to the heating element 40, it has been found that having the first amount of power to be between 10%-25% more than the second amount of power has been found to be a suitable increase in power which more optimally achieves the desired temperature/properties in the generated aerosol, yet which does not provide so much power to waste power from the power source of the aerosol provision system 1 and/or potentially which reduces the likelihood of overheating the aerosol-generating material used to generate the aerosol (noting such overheating may in some instances impair the flavour of any generated aerosol using such aerosol-generating material).

In a very particular embodiment, it has been found that having the first amount of power to be greater than 5.8 W, and/or the second amount of power to be less than 5.7 W, has been found to be a particularly effective power transition level for the heating element 40.

In some related embodiments, it has been found that any employed control circuitry, as well as being used to vary the amount of power which is delivered to the heating element in response to their being an output from the temperature-detecting portion which is indicative of a temperature which is too cold, may additionally/alternatively be used to vary the amount of power which is delivered to the heating element in response to their being an output from the temperature-detecting portion which is indicative of a temperature which is too warm. Such a temperature might be, for instance, any temperature which is greater than, or equal to, 30° C. Hence this might be the case, for instance, where the aerosol provision system 1 is otherwise used in a particularly warm climate, such as in a location which is closer to the Earth's equator, or otherwise used on a particularly hot summer's day.

Thus in accordance with some of these embodiments, it may be the case that the control circuitry is configured to determine whether the output is indicative of a temperature which is equal to, or greater than, a second predetermined temperature (which in some very particular embodiments might be greater than, or equal to, 30° C.), and be configured provide the second amount of power which is delivered to the heating element in response to determining that the output is indicative of a temperature which is less than the second predetermined temperature; and provide a third amount of power, which is less than the second amount of power, which is delivered to the heating element in response to determining that the output is indicative of a temperature which is equal to, or greater than, the second predetermined temperature.

To the extent in such embodiments where a differing second/third amounts of power may be delivered to the heating element 40, it has been found that having the second amount of power to be between 10%-25% more than the third amount of power has been found to be a suitable increase in power which more optimally achieves the desired temperature/properties in the generated aerosol.

Appreciating the foregoing disclosure therefore, it may be seen that the presence of the temperature-detecting portion 200 may allow for the aerosol provision system 1 to modify an amount of power which is delivered to its heating element 40, such to modify the temperature of the aerosol which is generated in the aerosol generation region of the aerosol provision system 1, depending on the temperature of air surrounding, or passing into, the aerosol provision system 1. In this way, and as described above, this may allow for the generated aerosol to be customised/optimised to cater for different ambient temperatures (e.g. providing a relatively warmer aerosol in the case of a relatively cooler ambient set of conditions).

To the extent any temperature-detecting portion 200 is employed, it has been recognised that the temperature-detecting portion 200 may be potentially affected by any heat generated by the heating element 40 in use. Thus in accordance with some embodiments, to better prevent any heat from the heating element 40 from impacting the output from the temperature-detecting portion 200, this may be better achieved in some embodiments by having the temperature-detecting portion spaced from the heating element by at least 2 mm, or in some more limited embodiments by at least 3 mm, or in yet further limited embodiments spaced by at least 4 mm. By the phrase spaced from the heating element 40 here, this may be understood as meaning that no part of the heating element 40 is within the specified distance to any part of the temperature-detecting portion 200. In this way therefore, and through the provision of this separation between the heating element 40 and the temperature-detecting portion 200, this may better separate the temperature-detecting portion 200 from any heat generated by the heating element 40.

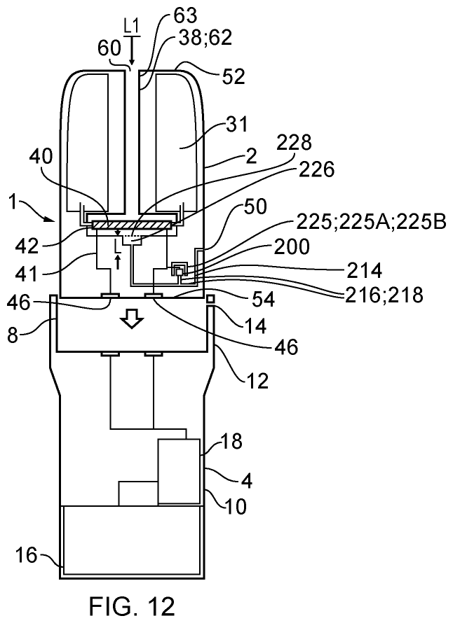

In some related alternative/additional embodiments, the temperature-detecting portion 200 may be better protected from the heating effects of the heating element 40 by having the temperature-detecting portion 200 thermally insulated, or at least partially thermally insulated, from the heating element 40. This may be achieved in some embodiments (such as that shown in FIG. 12) by adding a thermally insulating material 225;225A, between the temperature-detecting portion 200 and the heating element 40. This thermally insulating material 225;225A could take several forms, as required, such as a plug portion of the aerosol provision system (such as the plug 44 shown in the embodiment from FIG. 5B, for example) which separates any employed temperature-detecting portion 200 from the heating element 40, or some material which at least partially surrounds, or is wrapped around, the temperature-detecting portion 200 (as shown in the embodiment from FIG. 12).

More fundamentally, it has been also been found that avoiding a direct line-of-sight between the temperature-detecting portion 200 and the heating element 40 (as shown, for example, in the embodiments from FIGS. 7B and 12) has been found to help to mitigate the effects of any heat from the heating element 40 otherwise affecting the output of the temperature-detecting portion 200, more-so than if such a line-of-sight was otherwise present.

It has also been found that in so far as heat output from the heating element 40 may potentially adversely effect the output of the temperature-detecting portion 200, this same output from the temperature-detecting portion 200 may also be adversely affected in some instances by environmental conditions imposed on the outer walls of the aerosol provision system 1. For example, in so far as an outer wall of the aerosol provision system 1 might potentially get wet/splashed, or get rained on, in use, then to the extent the temperature-detecting portion 200 is too close to this outer wall, this wetness on the outer wall may disproportionally cool this outer wall, and thus potentially disproportionally cool any temperature-detecting portion 200 otherwise in sufficient proximity to this outer wall. Thus to better prevent such environmental moisture conditions from otherwise adversely impacting (cooling) the output of the temperature-detecting portion 200, then in accordance with some embodiments where there is provided an air inlet 50 for delivering air into the air inlet channel, wherein the air inlet 50 defines an orifice in an outer wall of the aerosol provision system 1, the temperature-detecting portion 200 may be separated from the outer wall of the aerosol provision system by at least 2 mm (as shown, for example, in the embodiments from FIG. 7B and FIG. 12).

Equally, in some related alternative/additional embodiments, the temperature-detecting portion 200 may be better protected from any cooling as a result of any localised wetting of the outer wall (e.g. caused by rain, or a splash) by having the temperature-detecting portion 200 thermally insulated, or at least partially thermally insulated, from the outer wall. This may be achieved in some embodiments by adding a thermally insulating material 225;225B between the temperature-detecting portion 200 and the outer wall. This thermally insulating material 225;225B could take several forms, as required, such as a plug portion of the aerosol provision system (such as the plug 44 shown in the embodiment from FIG. 5B, for example) which separates any employed temperature-detecting portion 200 from outer wall, or some material 225;225B which at least partially surrounds, or is wrapped around, the temperature-detecting portion 200 (as shown, for example, in the embodiment from FIG. 12).

Referring back to the line-of-sight point as well, it has been also been found that avoiding a direct line-of-sight between the temperature-detecting portion 200 and the air inlet 50 (as shown, for example, in the embodiments from FIG. 7B and FIG. 12) has helped to mitigate the effects of any potential wind-driven rain otherwise impinging, and thus causing unwanted cooling of, the temperature-detecting portion 200, more-so than if such a line of sight was otherwise present.

Related to the above theme of avoiding wind-driven rain, or for that matter other detritus in the air passing through the air inlet channel, from otherwise impinging on the temperature-detecting portion 200, it has also been found that such impingements may be reduced in embodiments where the orifice 216 is located at a first end of the passage 218, and where the temperature-detecting portion 200 is then shielded inside this passage 218 to some extent, for instance by having the temperature-detecting portion 200 located in the passage 218, or located at a second end of the passage 218 which is opposite the first end of this passage (as shown for example, in the embodiment from FIG. 12).

With respect to any temperature detecting portion 200 which may be employed, it may also be the case that in some embodiments, the presence of the temperature detecting portion 200 may have an impact on the fluid dynamics of the air which passes it, and which ultimately passes from the air inlet channel 214 to the heating element 40. Thus to help optimise any such (disturbed) fluid dynamic properties of the air which passes the temperature detecting portion 200, in accordance with some embodiments (such as that shown in the embodiment relating to FIG. 12), the air inlet channel 214 (or the wider aerosol provision system 1) in accordance with some embodiments may further comprise a plenum chamber 226, wherein the plenum chamber 226 is configured to receive air passing through the air inlet channel 214. In this way, the plenum chamber 226 may be then located in the air inlet channel 214 in a position which is upstream of the heating element 40, yet also downstream of the temperature-detecting portion 200. In this way, any such employed plenum chamber 226 may be configured to help optimise the fluid dynamic properties of air passing through the air inlet channel 214 to be better suited for passing the heating element 40. This optimisation, in some embodiments, may be further achieved through having the plenum chamber 226 comprise at least one (or a plurality of) orifice 228 through which the air from the air inlet channel 214 is configured to pass through. In some very particular embodiments, each such orifice 228 may have a maximum width of no more than 3 mm. To the extent any such orifice(s) 228 may be provided as part of the plenum chamber 226, in some particular embodiments (such as that shown in FIG. 12B, for example), the at least one orifice 228 may be located in a wall of the plenum chamber 228 which is substantially perpendicular to a length direction L of the plenum chamber 228. Although not necessarily required, in accordance with some embodiments—such as that shown in the embodiment of FIG. 12, the length direction L of the plenum chamber 226 may be parallel to a length direction L1 of the aerosol provision system 1, since this has been found to better orientate the flow of air through the plenum chamber 226 with respect to the overall length L1 of the aerosol provision system 1—and towards the mouthpiece outlet 60 at the mouthpiece end of this length L1 of the aerosol provision system 1.

As explained previously, any employed temperature-detecting portion 200 may, though does not have to, be used as part of a two-part aerosol provision device 2/consumable 4 arrangement for the aerosol provision system 1, such that in some of these two-part arrangements there may also be appreciably provided (for example as shown in the embodiment of FIG. 7A) a consumable 4 for an aerosol provision system 1 comprising the consumable 4 and an aerosol provision device 2 configured to receive the consumable 2, wherein the consumable comprises: a heating element 40 for heating aerosol-generating material from a reservoir 31 to generate an aerosol in an aerosol generation region of the aerosol provision system 1. In this way, the aerosol provision device 4 may comprise the temperature-detecting portion 200 which is configured to generate an output based on the temperature of air surrounding, or passing into, the aerosol provision system 1, and wherein the aerosol provision system 1 is configured to modify an amount of power which is delivered to the heating element 40, such to modify the temperature of the aerosol which is generated in the aerosol generation region, depending on a temperature of air surrounding, or passing into, the aerosol provision system 1, based on the output from the temperature-detecting portion.

Appreciating the above disclosures as well, it is also to be appreciated the present disclosure provides for a number of different methods of varying the temperature of an aerosol delivered from an aerosol provision system 1, based on temperature of air surrounding, or passing into, the aerosol provision system 1. For example, one such method may include a method of varying the temperature of an aerosol delivered from an aerosol provision system 1, the method comprising: generating an output, from a temperature-detecting portion 200 of the aerosol provision system 1, which is indicative of a temperature of air surrounding, or passing into, the aerosol provision system 1; the aerosol provision system 1 using the output to determine whether to modify an amount of power which is delivered to the heating element 40 such to modify the temperature of the aerosol which is generated in the aerosol generation region.

To the extent such a method is employed, in some embodiments the aerosol provision system 1 using the output to determine whether to modify the amount of power which is delivered to the heating element 40 may further comprise the aerosol provision system 1: determining whether the output is indicative of a temperature which is less than, or equal to, a predetermined temperature; and providing a first amount power which is delivered to the heating element 40 in response to determining that the output is indicative of a temperature which is less than, or equal to, the predetermined temperature; and providing a second amount power, which is less than the first amount of power, which is delivered to the heating element 40 in response to determining that the output is indicative of a temperature which is greater than the predetermined temperature.

Purely for completeness, with respect to any employed embodiments where the aerosol provision system 1 comprises a temperature-detecting portion 200 which is configured to operate in conjunction with any control circuitry 18 from the aerosol provision system 1, it is envisaged in some embodiments that the aerosol provision system 1 may be configured to wirelessly transmit the output from the temperature-detecting portion 200 to the control circuitry 18 (for example as shown in the embodiment of FIG. 7C), as opposed to via a wired connection between the temperature-detecting portion 200 and the control circuitry 18 (for example as shown in the embodiments of FIGS. 7A and 7B). Although not necessarily, in a particularly convenient embodiment, the output from the temperature-detecting portion 200 may be wirelessly transmitted to the control circuitry 18 by a Bluetooth® protocol in accordance with some embodiments.

The above being said, a wired connection may appreciably be additionally/alternatively employed in accordance with some embodiments, particularly in instances where a more reliable connection is required between the temperature-detecting portion 200 and the control circuitry 18. In this way, the aerosol provision system 1 may be configured to transmit the output from the temperature-detecting portion 200 by a wired, or physical, connection. For example, in some embodiments where the temperature-detecting portion 200 is located in the consumable 4, yet the control circuitry 18 is located in the aerosol provision device 2, the aerosol provision system may be configured to deliver the output from the temperature-detecting portion 200 to the control circuitry 18 via any combination of the electrical contacts/electrodes 46 and/or leads 41 from the aerosol provision system 1, which are otherwise used to also deliver power to the heating element/vaporiser 40.

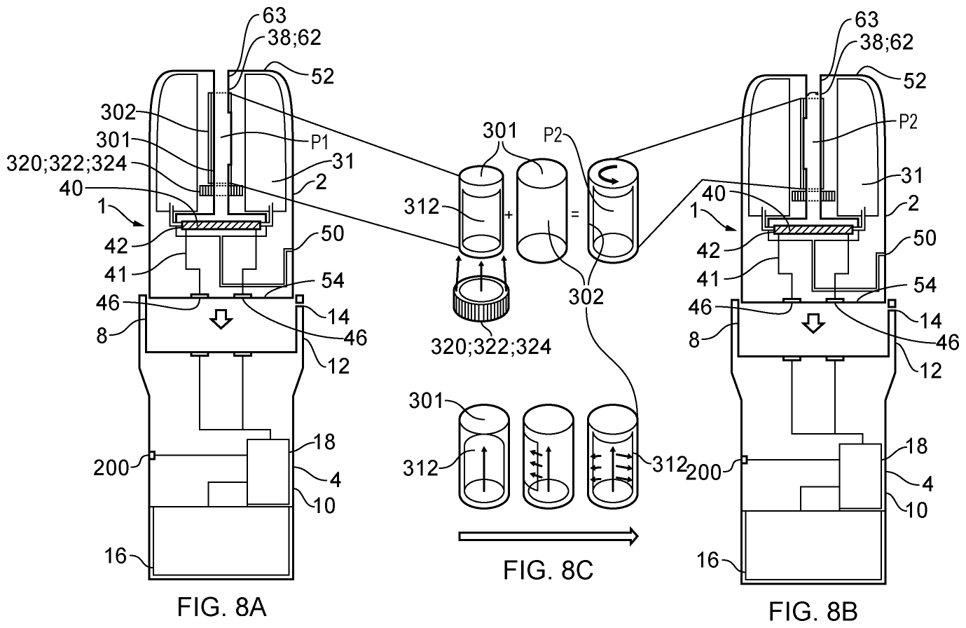

Turning now to the embodiments from FIGS. 8A-10B and FIG. 11, the present disclosure also provides an aerosol provision system 1 whose aerosol outlet channel 63 (which may be understood as forming the combination of features 38;62 from FIGS. 1-6B), for delivering the aerosol from the aerosol generation region to the outlet 60 of the aerosol provision system 1, may be moveable between a first configuration P1 and a second configuration P2 such that a greater temperature change is configured to be effected in the aerosol, whilst the aerosol passes through the aerosol outlet channel 63, when the aerosol outlet channel 63 is in the second configuration P2 than when the aerosol outlet channel is in the first configuration P1.

At a general therefore, the provision of such an adjustable aerosol outlet channel 63, which may be downstream of the heating element/vaporiser 40 and/or upstream of the outlet 60/mouthpiece outlet 60, may allow for the temperature of an aerosol delivered to a user to be controlled as required. As will be described, it is envisaged that this adjustment of the aerosol outlet channel 63 may be configured to allow a user to either manually adjust the aerosol outlet channel 63 between the first and second configurations P1;P2, and/or in some additional/alternative embodiments may be configured to allow control circuity 18 from the aerosol provision system 1 to effect this adjustment (for instance in response to the output from the temperature-detecting portion 200 being indicative of a temperature which is greater than the predetermined temperature, the control circuitry 18 may be configured to move the aerosol outlet channel 63 from the first configuration to, or towards, the second configuration P2, such to help cool the aerosol passing through the aerosol outlet channel 63, as will be described).

At a general level therefore, the aerosol outlet channel 63 may thus be adjusted, either manually by the user, or automatically, for allowing a varying temperature change to be effected in the aerosol, whilst the aerosol passes through the aerosol outlet channel, depending on whether the aerosol outlet channel is in the first and/or second configurations P1;P2.

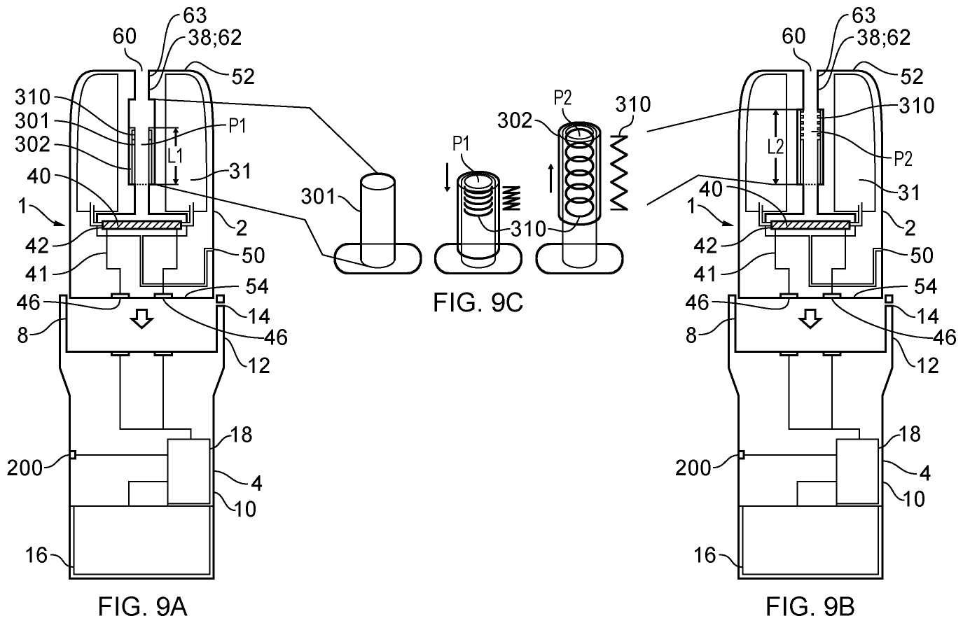

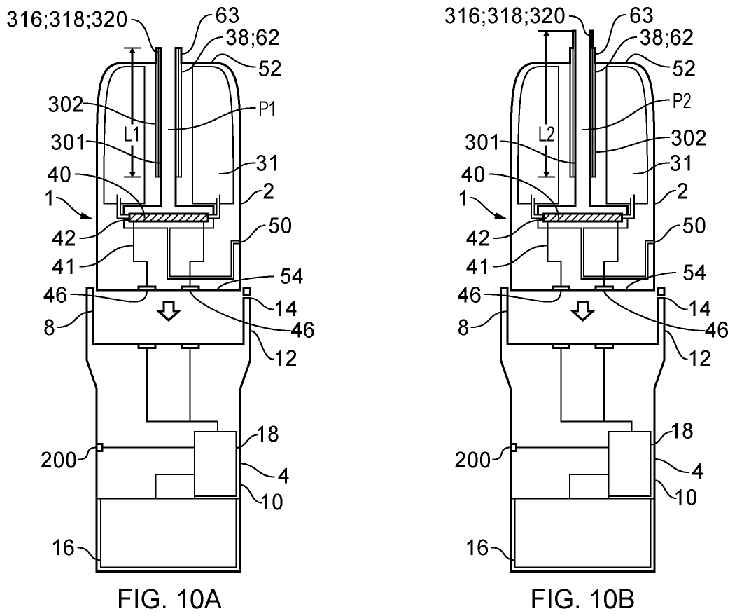

In terms of how this varying temperature change may be achieved, at a general level (relating to all of the embodiments from FIGS. 8A-8C; FIGS. 9A-9C; and FIGS. 10A-10B), some embodiments may employ the aerosol outlet channel 63 comprising a first portion 301 and a second portion 302, wherein the first portion 301 is configured to move relative to the second portion 302 as the aerosol outlet channel moves 63 between the first configuration P1 and the second configuration P2. In this way, it may be seen that a greater amount of the second portion 302 may be configured to be exposed to the aerosol in the aerosol outlet channel when the aerosol outlet channel is in the second configuration P2 than when the aerosol outlet channel is in the first configuration P1. With this general operation, and to the extent that the second portion 302 in some embodiments might comprise a material that is more thermally conductive than the material of the first portion 301, such as in a very particular embodiment where the second portion 302 comprises at least one metal and/or the first portion 301 comprises at least one plastic material, by having a greater amount of the second portion 302 exposed to the aerosol in the aerosol outlet channel when the aerosol outlet channel is in the second configuration P2 than when the aerosol outlet channel is in the first configuration P1, this may allow a greater temperature change to be effected in the aerosol, whilst the aerosol passes through the aerosol outlet channel, when the aerosol outlet channel is in the second configuration P2 (as shown in the embodiment configurations from FIGS. 8B and 9B), compared with the first configuration P1 (as shown in the embodiment configurations from FIGS. 8A and 9A). In this way, a particular application of this arrangement might be where the aerosol provision system 1 is being used at a particular hot/warm time, and/or where the user would prefer to be delivered a relatively cooler aerosol which is more to their liking. In these instances, the user may manually (or the control circuitry 18 may automatically, e.g. based on the output of the temperature-detecting portion 200) move the aerosol outlet channel 63 away from the first configuration P1 towards or to the second configuration P2, such to effect a greater temperature change (reduction) in the aerosol passing through the aerosol outlet channel 63—as result of this aerosol being exposed to more of the (more thermally conductive) second portion 302, such to help cool the aerosol more before it reaches the aerosol outlet/mouthpiece outlet 60.

Mindful of this general operation, it may be seen that how the aerosol outlet channel 63 exactly moves between the first and second configurations P1;P2 may vary—depending on the embodiment.

For example, it may be seen that in some embodiments (such as that shown in the embodiment of FIGS. 8A-8C), the first portion 301 may be configured to rotate relative to the second portion 302, as the aerosol outlet channel 63 moves between the first configuration P1 and the second configuration P2. Related to this, it may be appreciated that in some embodiments, the aerosol outlet channel may be configured to rotate between the first configuration P1 and the second configuration P2. In some related embodiments too (again as shown in the embodiment of FIGS. 8A-8C, but also the embodiment of FIGS. 9A-9C), the first portion 301 may be located within, and/or be concentric with, the second portion 302. In some embodiments, either the first and/or second portions may also be tubular—again as shown in the embodiments of FIGS. 8A-8C; FIGS. 9A-9C, and FIGS. 10A-10B.

Rather than employing rotational movement, the first portion 301 in some additional/alternative embodiments may be configured to translate/slide relative to the second portion 302. In this way, and in some embodiments (as shown in the embodiment from FIGS. 9A-9C and FIGS. 10A-10B), it may be seen that the first portion 301 may be configured to translate relative to the second portion 302 as the aerosol outlet channel 63 moves between the first configuration P1 and the second configuration P2. Phrased differently, in some embodiments the first portion 301 may be configured to not rotate relative to the second portion P2 as the aerosol outlet channel moves between the first configuration and the second configuration; and/or may be such that the first portion 301 is configured to separate from the second portion 302 (potentially telescopically, in some cases) as the aerosol outlet channel moves from the first configuration to the second configuration. Such a latter embodiment is shown in that of FIGS. 9A-9C, where it can be seen that the second, outer, portion 302 separates away from the first, inner, portion 301 as the aerosol outlet channel 63;63 moves from the first configuration P1 towards the second configuration P2.

To be clear, it need not necessarily be the case that the second portion 302 be made from a different material to that of the first portion 301 for effecting different temperature changes in either the first or second configurations P1;P2. For example, and as shown in the embodiment of FIGS. 9A-9C, in some embodiments, there may be provided a thermally conductive portion 310 which is configured to be more exposed to aerosol passing through the aerosol outlet channel 63 when the aerosol outlet channel is in the second configuration P2 than when the when the aerosol outlet channel is in the first configuration P1. Where such a thermally conductive portion 310 is employed, this could comprise, or be made of, metal, for example, such to allow the thermally conductive portion 310 to transfer more of the heat away from the aerosol as it passes through the aerosol outlet channel 63 whilst in its second configuration.

To the extent any such thermally conductive portion 310 is employed, such a thermally conductive portion 310 in accordance with some embodiments may be configured to have a relatively high surface area to volume ratio, for best allowing the thermally conductive portion 310 to transfer heat away from the aerosol passing through the aerosol outlet channel 63, whilst not occupying more space than necessary within the aerosol provision system 1 as a whole. Mindful of this, and in some embodiments, the thermally conductive portion 310 may comprise a helical portion (as shown in the embodiment of FIGS. 9A-9C) which is configured to be exposed to, and/or surround, the aerosol in the aerosol outlet channel 63 when the aerosol outlet channel is in the second configuration P2, nothing this helical shape has been found to assist with providing such a thermally conductive portion 310 with a relatively high surface area which can be exposed to the aerosol passing through the aerosol outlet channel 63.

Staying with the thermally conductive portion 310, to the extent that this feature is employed, it may also be seen in some embodiments (as shown best in the embodiment of FIG. 9B versus FIG. 9A) that a greater surface area of the thermally conductive portion 310 may be exposed to aerosol passing through the aerosol outlet channel 63 when the aerosol outlet channel 63 is in the second configuration P2 than when the aerosol outlet channel is in the first configuration P1 (such to allow the thermally conductive portion 310 to transfer more of the heat away from the aerosol as it passes through the aerosol outlet channel 63 whilst in its second configuration P2). In this way, the thermally conductive portion 310 may be deemed as effectively passively cooling the aerosol passing through the aerosol outlet channel when the aerosol outlet channel is in the second configuration P2, or in some more specific embodiments may be said to be passively cooling aerosol passing through the aerosol outlet channel 63 when the aerosol outlet channel in both the first configuration P1 and the second configuration P2, but passively cooling the aerosol passing through the aerosol outlet channel by a greater amount/extent/rate when the aerosol outlet channel is in the second configuration P2 (as illustrated in the embodiment shown at FIG. 9B, where there is a relatively greater surface area of the thermally conductive portion 310 exposed to the aerosol passing through the aerosol outlet channel 63) than when the aerosol outlet channel is in the first configuration P1 (as illustrated in the embodiment shown at FIG. 9A, where there is a relatively lesser surface area of the thermally conductive portion 310 exposed to the aerosol passing through the aerosol outlet channel 63).

Irrespective of whether any thermally conductive portion 310 is employed or not, it may be appreciated that in some embodiments, the first portion 301 may comprise at least one, or more than one, window 312 and/or aperture 312 for allowing aerosol, passing through the aerosol outlet channel 63, to be exposed to the second portion 302, through each window/aperture, when the aerosol outlet channel 63 is in second configuration P2. In some embodiments, the second portion 302 may be less exposed, or not exposed at all, when in the first configuration P1. Such an embodiment may be seen, for example, in that from FIGS. 8A-8C, where the provision of the window 312/aperture 312 allows the window 312/aperture 312 to expose the (more thermally conductive) first portion 301 through the window when the aerosol outlet channel 63 is in the second configuration P2 (as shown in FIG. 7B), and which also allows the first portion 301 to be rotated relative to the second portion 302 to then not have the window expose the aerosol in the aerosol outlet channel 63 to the first portion 301 when the aerosol outlet channel 63 is in the second configuration P1 (as shown in FIG. 8A).

To be clear as well, in so far as the aerosol outlet channel 63 is operable to move (either manually by the user, or automatically) between the first and second configuration P1;P2, it will be entirely appreciated that in some of these embodiments at least, a progressively greater amount of the second portion 302 may be configured to be exposed to the aerosol in the aerosol outlet channel as the aerosol outlet channel progressively moves from the first configuration P1 to the second configuration P2. Phrased differently, it may be seen that in some embodiments, the aerosol outlet channel may be moveable to least one (or a plurality of) intermediary configurations, as the aerosol outlet channel 63 is moved between the first configuration P1 and the second configuration P2, such that each intermediary configuration is between the first configuration and the second configuration. In this way, each intermediary configuration of the aerosol outlet channel may be configured to effect a respective temperature change in the aerosol, whilst the aerosol passes through the aerosol outlet channel, when the aerosol outlet channel is in that intermediary configuration, wherein the respective temperature change for each intermediary configuration is i) greater than the temperature change from the first configuration; and ii) less than the temperature change from the second configuration. So via the provision of such arrangements, it may be seen the temperature change, configured to be effected in the aerosol, may progressively increase as the aerosol outlet channel 63 is progressively moved from the first configuration P1 to the second configuration P2, as opposed to there being just two binary configuration P1 and P2.

Related to the embodiments from FIGS. 8A-9C, a further embodiment which allows the aerosol outlet channel 63 to move between the first configuration P1 and the second configuration P2 is as shown in FIGS. 10A-10B, which shows the first portion 301 of the aerosol outlet channel 63 being configured to move/translate/slide relative to the second portion 302 as the aerosol outlet channel moves between the first configuration P1 and the second configuration P2, such that the length of the aerosol outlet channel 63 is configured to vary as the aerosol outlet channel moves between the first configuration P1 and the second configuration P2. In accordance with this embodiment, and potentially other embodiments, it may be thus seen that the aerosol outlet channel is longer in the second configuration P2 (as shown in the configuration of FIG. 10B) than when the aerosol outlet channel 63 is in the first configuration P1. Phrased differently, it may also be seen in embodiments such as this, and potentially others such as that shown in FIGS. 9A-9C, that the combined length of the first and second portions 301;302 is longer in the second configuration P2 of the aerosol outlet channel 63 (as shown in FIGS. 9B and 10B depicted by combined length L2 for the first and second portions 301;302) than in the first configuration P1 of the aerosol outlet channel 63 (as shown in FIGS. 9A and 10A depicted by combined length L1 for the first and second portions 301;302). In this way as well, it may be seen that in so far as the aerosol outlet channel 63 comprises an internal surface area which is configured to be exposed to the aerosol passing through the aerosol outlet channel 63, the internal surface area is configured to be larger in the second configuration P2 of the aerosol outlet channel 63 than when the aerosol outlet channel 63 is in the first configuration P1.

With respect to some of the embodiments described above, it may be seen that in some of these embodiments, the length of the aerosol outlet channel (and/or the combined length of the of the first and second portions 301;302) may be at least 15% longer in the second configuration than when the aerosol outlet channel is in the first configuration. By increasing length in this way, or put differently by changing the profile of the aerosol outlet channel in this way between the first configuration P1 and the second configuration P2, the user may also be able to more easily identify when the aerosol outlet channel is in either configuration P1/P2—particularly in instances where the reservoir comprises a transparent portion, such as a window or some other transparent wall of the reservoir 31, through which the user may observe the aerosol outlet channel 63 inside the aerosol provision system 1.

On a final note with respect to potentially changing the length of the aerosol outlet channel (and/or the combined length of the of the first and second portions 301;302), in some particularly space saving embodiments, such as those shown in FIGS. 9A-9C and 10-10B, in some embodiments changing this length may comprise telescopically changing this length, such that the first portion 301 of the aerosol outlet channel 63 is configured to at least partially overlap/slide relative to the second portion 302 of the aerosol outlet channel 63 as the aerosol outlet channel 63 moves between the first and second configurations P1;P2.

In terms of the positioning of any such aerosol outlet channel 63, together with any of its employed first/second portions 301;302, a particularly convenient/compact location for the aerosol outlet channel 63, in some embodiments, is such that the reservoir 31 surrounds the aerosol outlet channel 63, and/or such that the reservoir 31 is annular—as can be seen with respect to the embodiments from the Figures.

With respect also to how the aerosol outlet channel 63 is configured to move about its first and second configurations P1;P2, as stated previously, in accordance with some embodiments the aerosol outlet channel 63 may be configured to move, either manually by the user, or automatically, for allowing a varying temperature change to be effected in the aerosol, whilst the aerosol passes through the aerosol outlet channel, depending on whether the aerosol outlet channel is in the first and/or second configurations P1;P2. Where the movement is configured to be effected by the user, it may be appreciated that this movement might require the user to the perform any combination of the following actions on the aerosol outlet channel 63, including i) pulling the aerosol outlet channel, or pulling a portion of the aerosol outlet channel; ii) pushing the aerosol outlet channel, or pushing a portion of the aerosol outlet channel iii) rotating the aerosol outlet channel, or rotating a portion of the aerosol outlet channel (such as rotating the second portion 302 of the aerosol outlet channel relative to the first portion 301 of the aerosol outlet channel in the case of the embodiment relating to FIGS. 8A-8B); iv) twisting the aerosol outlet channel, or twisting a portion of the aerosol outlet channel (such as twisting the second portion 302 of the aerosol outlet channel relative to the first portion 301 of the aerosol outlet channel in the case of the embodiment relating to FIGS. 8A-8B); and/or v) sliding the aerosol outlet channel, or sliding a portion of the aerosol outlet channel (such as sliding the second portion 302 of the aerosol outlet channel relative to the first portion 301 of the aerosol outlet channel in the case of the embodiment relating to FIGS. 10A-10B).

Depending on the construction of any employed aerosol provision system 1 as well, it will be appreciated the aerosol provision system 1 may be provided with any appropriate mechanism(s)/mean(s) for allowing a user to move the aerosol outlet channel 63 about its first/second configurations, as required. For example, in the embodiment relating to FIGS. 10A-10B, the user may be configured to grip/move a mouthpiece portion 316 of the aerosol provision system 1, which in the embodiment from FIGS. 10A-10B is a mouthpiece portion 316 which is formed by a projecting portion 318 of the aerosol outlet channel 63 about which a user is configured to place their lips around, for moving the aerosol outlet channel 63 between the first configuration P1 and the second configuration P2.

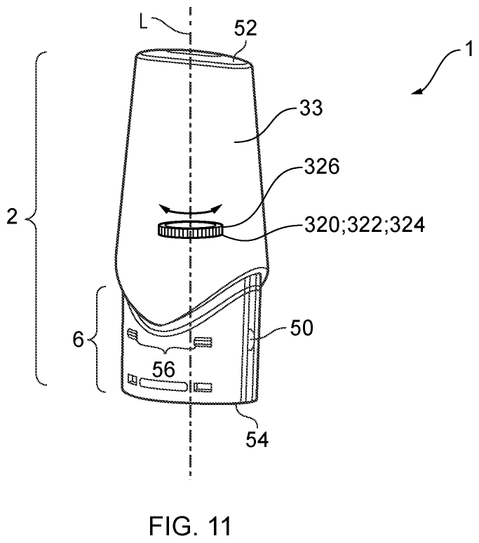

Appreciably however, in some additional/alternative embodiments, the aerosol provision system 1 may be provided with an access point 320 for allowing a user to access/move the aerosol outlet channel 63 between the first configuration P1 and the second configuration P2. For example, such an access point 320 in some embodiments could comprise a recess, or opening, in a portion of the aerosol provision system 1 through which the user can move the aerosol outlet channel 63. In some embodiments, the access point 320 might comprise an actuator 322 (e.g. including any of a lever; a switch; and/or a rotatable portion 324, or a button), which is operatively or mechanically connected with the aerosol outlet channel 63, and which might potentially extend through a portion 326 of the aerosol provision system 1, as shown for example in the FIG. 8C and as shown in FIG. 11. It is to be clear though, that the provision of this access point 320 need not be compulsory, to the extent that the aerosol outlet channel 63 can be moved in some other way, e.g. because a portion of the aerosol outlet channel is externally accessible to allow a user to manipulate/move the aerosol outlet channel 63 from that external location, or because the aerosol outlet channel might otherwise be configured to be move automatically—without the need for user intervention/handling, as noted previously—via the use of any employed temperature-detecting portion 200 and/or control circuitry 18 from the aerosol provision system 1.

Mindful of the above therefore, it may be seen that any potential aerosol outlet channel 63 which is configured to move between the first configuration P1 and the second configuration P2 could appreciably be used in the context of either a single-part aerosol provision system 1, or equally in the context of a two-part aerosol provision device 2/consumable 4 arrangement—as shown in the example embodiments from FIGS. 8A-11. Mindful of this, it will also be appreciated that the present disclosure may provide for a consumable 2 for an aerosol provision system 1 comprising the consumable 2 and an aerosol provision device 4 configured to receive the consumable 2, wherein the consumable 2 comprises: the heating element 40 for heating aerosol generating material from the reservoir 31 to generate an aerosol in an aerosol generation region; and the aerosol outlet channel 38;62;63 for delivering the aerosol from the aerosol generation region to the outlet 60, such as mouthpiece outlet 60, of the aerosol provision system 1. In this way, and in some embodiments, the aerosol outlet channel may be moveable between the first configuration P1 and the second configuration P2 such that a greater temperature change is configured to be effected in the aerosol, whilst the aerosol passes through the aerosol outlet channel 63, when the aerosol outlet channel is in the second configuration P2 than when the aerosol outlet channel is in the first configuration P1.

Appreciating the foregoing disclosure as well, also disclosed herein, in accordance with some embodiments, is a method of varying the temperature of an aerosol delivered from an aerosol provision system 1, the method comprising:
generating an aerosol, from aerosol-generating material, in an aerosol generation region using a heating element 40 which heats the aerosol-generating material;
delivering the aerosol from the aerosol generation region, via an aerosol outlet channel 63 of the aerosol provision system 1, to an outlet 60 of the aerosol provision system 1;
wherein the method further comprises:
moving the aerosol outlet channel between a first configuration P1 and a second configuration P2 to effect a temperature change in the aerosol, whilst the aerosol passes through the aerosol outlet channel 63, wherein a greater temperature change is configured to be effected in the aerosol, whilst the aerosol passes through the aerosol outlet channel 63, when the aerosol outlet channel 63 is in the second configuration P2 than when the aerosol outlet channel is in the first configuration P1.

Appreciating the foregoing disclosure as well, also disclosed herein, in accordance with some embodiments, is a method of varying the temperature of an aerosol passing through an aerosol outlet channel 63 from an aerosol provision system 1, the method comprising:
moving the aerosol outlet channel 63 between a first configuration and a second configuration to effect a temperature change in the aerosol, whilst the aerosol passes through the aerosol outlet channel 63, wherein a greater temperature change is configured to be effected in the aerosol, whilst the aerosol passes through the aerosol outlet channel 63, when the aerosol outlet channel 63 is in the second configuration P2 than when the aerosol outlet channel 63 is in the first configuration P1.

Appreciating the foregoing therefore, there has accordingly been described a variety of different aerosol provision systems, and corresponding methods employing the same, which all look to provide for various arrangements for allowing the temperature of a delivered aerosol from the aerosol provision system to be better controlled, either manually by a user, or automatically as described herein.

Bearing this in mind, the above noted disclosures may thus appreciably relate to the additional embodiments as set out in the following numbered clauses at the end of this specification, alongside the other noted embodiments from the below noted claims.

There has also been described an aerosol provision system 1 comprising a heating element 40 for heating aerosol-generating material from a reservoir 31 to generate an aerosol in an aerosol generation region of the aerosol provision system 1. The aerosol provision system 1 is configured to modify an amount of power which is delivered to the heating element 40, such to modify the temperature of the aerosol which is generated in the aerosol generation region, depending on a temperature of air surrounding, or passing into, the aerosol provision system 1, based on an output from a temperature-detecting portion 200 from the aerosol provision system 1. This thus allows the temperature of the aerosol to be customised/optimised for different ambient temperatures.

In order to address various issues and advance the art, this disclosure shows by way of illustration various embodiments in which the claimed invention(s) may be practiced. The advantages and features of the disclosure are of a representative sample of embodiments only, and are not exhaustive and/or exclusive. They are presented only to assist in understanding and to teach the claimed invention(s). It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope of the claims. Various embodiments may suitably comprise, consist of, or consist essentially of, various combinations of the disclosed elements, components, features, parts, steps, means, etc. other than those specifically described herein, and it will thus be appreciated that features of the dependent claims (or any herein recited dependent clauses) may be combined with features of the independent claims (or independent clauses) in combinations other than those explicitly set out in the claims or clauses. The disclosure may include other inventions not presently claimed, but which may be claimed in future. Accordingly, any permutation of the features from the claims may be combined as required, and/or may be combined with any permutation of the features from the herein recited clauses at the end of this specification.

### First Set of Clauses

1. An aerosol provision system comprising:
   a heating element for heating aerosol-generating material from a reservoir to generate an aerosol in an aerosol generation region of the aerosol provision system;
   a temperature-detecting portion which is configured to generate an output based on the temperature of air surrounding, or passing into, the aerosol provision system;
   wherein the aerosol provision system is configured to modify an amount of power which is delivered to the heating element, such to modify the temperature of the aerosol which is generated in the aerosol generation region, depending on a temperature of air surrounding, or passing into, the aerosol provision system, based on the output from the temperature-detecting portion.
2. An aerosol provision system according to clause 1, wherein the temperature-detecting portion comprises a temperature sensor for outputting sensor data indicative of the temperature of air surrounding, or passing into, the aerosol provision system, wherein the output comprises the sensor data.
3. An aerosol provision system according to any preceding clause wherein the aerosol provision system further comprises:
   control circuitry configured to:
      receive the output from the temperature-detecting portion; and
      process the output to determine whether to modify the amount of power which is delivered to the heating element such to modify the temperature of the aerosol which is generated in the aerosol generation region.
4. An aerosol provision system according to any preceding clause, wherein the aerosol provision system further comprises:
   an air inlet channel for delivering air to the heating element;
   wherein the temperature of air surrounding, or passing into, the aerosol provision system comprises the temperature of the air in the air inlet channel.
5. An aerosol provision system according to clause 4, wherein the temperature-detecting portion is exposed to the air inside the air inlet channel.
6. An aerosol provision system according to clause 4 or 5, wherein the temperature-detecting portion is located in the air inlet channel.
7. An aerosol provision system according to any of clauses 4-6, wherein the air inlet channel further comprises a plenum chamber;
   wherein the plenum chamber is configured to receive air passing through the air inlet channel; and
   wherein the plenum chamber is located in the air inlet channel in a position which is upstream of the heating element and which is downstream of the temperature-detecting portion.
8. An aerosol provision system according to any of clauses 4-7, wherein the aerosol provision system further comprises an air inlet for delivering air into the air inlet channel.
9. An aerosol provision system according to clause 8, wherein the air inlet defines an orifice in an outer wall of the aerosol provision system.
10. An aerosol provision system according to clause 9, wherein the temperature-detecting portion is separated from the outer wall of the aerosol provision system by at least 2 mm.
11. An aerosol provision system according to clause 9 or 10, wherein the temperature-detecting portion is thermally insulated, or at least partially thermally insulated, from the outer wall of the aerosol provision system.
12. An aerosol provision system according to clause 11, wherein the aerosol provision system comprises a thermally insulating material, between the temperature-detecting portion and the outer wall of the aerosol provision system, for thermally insulating, or at least partially thermally insulating, the temperature-detecting portion from the outer wall of the aerosol provision system.
13. An aerosol provision system according to any of clauses 8-12, wherein there is no direct line-of-sight between the temperature-detecting portion and the air inlet.
14. An aerosol provision system according to any of clauses 4-13, wherein the air inlet channel comprises an orifice which is configured to deliver air from the air inlet channel to the temperature-detecting portion.
15. An aerosol provision system according to clause 14, wherein the aerosol provision system further comprises a passage which is in fluid communication with the temperature-detecting portion, wherein the orifice is configured to allow a portion of the air from the air inlet channel to pass into the passage, and wherein the orifice is optionally located at a first end of the passage.
16. An aerosol provision system according to clause 15, wherein the temperature-detecting portion is located in the passage, or is located at a second end of the passage which is opposite the first end.
17. An aerosol provision system according to any preceding clause, wherein the temperature-detecting portion is spaced from the heating element by at least 4 mm.
18. An aerosol provision system according to any preceding clause, wherein the temperature-detecting portion is thermally insulated, or at least partially thermally insulated, from the heating element.
19. An aerosol provision system according to any preceding clause, wherein there is no direct line-of-sight between the temperature-detecting portion and the heating element.
20. An aerosol provision system according to any preceding clause, wherein the aerosol provision system further comprises:
   an outer housing, wherein the heating element and the temperature-detecting portion are located within the outer housing.
21. An aerosol provision system according to any preceding clause, when further dependent on clause 3 at least, wherein the control circuitry being configured to:
   process the output to determine whether to modify the amount of power which is delivered to the heating element further comprises the control circuitry being configured to:
      determine whether the output is indicative of a temperature which is less than, or equal to, a predetermined temperature; and
      provide a first amount power which is delivered to the heating element in response to determining that the output is indicative of a temperature which is less than, or equal to, the predetermined temperature; and
      provide a second amount power, which is less than the first amount of power, which is delivered to the heating element in response to determining that the output is indicative of a temperature which is greater than the predetermined temperature.
22. An aerosol provision system according to clause 21, wherein the predetermined temperature is no greater than 15° C.
23. An aerosol provision system according to clause 21 or 22, wherein the predetermined temperature is no greater than 10° C.
24. An aerosol provision system according to any of clauses 21-23, wherein the predetermined temperature is above 0° C.
25. An aerosol provision system according to any of clauses 9-12, wherein the first amount of power is between 10%-25% more than the second amount of power.
26. An aerosol provision system according to any of clauses 9-13, wherein the first amount of power is greater than 5.8 W.
27. An aerosol provision system according to any of clauses 9-14, wherein the second amount of power is less than 5.7 W.
28. An aerosol provision system according to any preceding clause, wherein the temperature-detecting portion comprises a temperature dependent switch.
29. An aerosol provision system according to any preceding clause, wherein the temperature-detecting portion comprises a thermistor.
30. An aerosol provision system according to any preceding clause, wherein the temperature-detecting portion is located on an external surface of the aerosol provision system.
31. An aerosol provision system according to any preceding clause, wherein the aerosol provision system further comprises a consumable and an aerosol provision device configured to receive the consumable, wherein the consumable comprises the heating element.
32. An aerosol provision system according to clause 31, wherein the aerosol provision device comprise the temperature-detecting portion.
33. An aerosol provision system according to clause 32, wherein the temperature-detecting portion is located on an external surface of the aerosol provision device.
34. A consumable for an aerosol provision system comprising the consumable and an aerosol provision device configured to receive the consumable, wherein the consumable comprises:
   a heating element for heating aerosol-generating material from a reservoir to generate an aerosol in an aerosol generation region of the aerosol provision system;
   wherein the aerosol provision device comprises:
   a temperature-detecting portion which is configured to generate an output based on the temperature of air surrounding, or passing into, the aerosol provision system;
   wherein the aerosol provision system is configured to modify an amount of power which is delivered to the heating element, such to modify the temperature of the aerosol which is generated in the aerosol generation region, depending on a temperature of air surrounding, or passing into, the aerosol provision system, based on the output from the temperature-detecting portion.
35. A method of varying the temperature of an aerosol delivered from an aerosol provision system, the method comprising:
   generating an output, from a temperature-detecting portion of the aerosol provision system, which is indicative of a temperature of air surrounding, or passing into, the aerosol provision system;
   the aerosol provision system using the output to determine whether to modify an amount of power which is delivered to the heating element such to modify the temperature of the aerosol which is generated in the aerosol generation region.
36. A method according to clause 35, wherein the aerosol provision system using the output to determine whether to modify the amount of power which is delivered to the heating element further comprises the aerosol provision system:
   determining whether the output is indicative of a temperature which is less than, or equal to, a predetermined temperature; and
   providing a first amount power which is delivered to the heating element in response to determining that the output is indicative of a temperature which is less than, or equal to, the predetermined temperature; and
   providing a second amount power, which is less than the first amount of power, which is delivered to the heating element in response to determining that the output is indicative of a temperature which is greater than the predetermined temperature.

### Second Set of Clauses

1. An aerosol provision system comprising:
   a heating element for heating aerosol-generating material from a reservoir to generate an aerosol in an aerosol generation region;
   an aerosol outlet channel for delivering the aerosol from the aerosol generation region to an outlet of the aerosol provision system;
   wherein the aerosol outlet channel is moveable between a first configuration and a second configuration such that a greater temperature change is configured to be effected in the aerosol, whilst the aerosol passes through the aerosol outlet channel, when the aerosol outlet channel is in the second configuration than when the aerosol outlet channel is in the first configuration.
2. An aerosol provision system according to clause 1, wherein the aerosol outlet channel is further moveable to least one intermediary configuration, as the aerosol outlet channel is moved between the first configuration and the second configuration, such that each intermediary configuration is between the first configuration and the second configuration;
   wherein each intermediary configuration of the aerosol outlet channel is configured to effect a respective temperature change in the aerosol, whilst the aerosol passes through the aerosol outlet channel, when the aerosol outlet channel is in that intermediary configuration;
   wherein the respective temperature change for each intermediary configuration is:
      i) greater than the temperature change from the first configuration; and
      ii) less than the temperature change from the second configuration.
3. An aerosol provision system according to clause 1 or 2, wherein the temperature change configured to be effected in the aerosol is configured to progressively increase as the aerosol outlet channel is progressively moved from the first configuration to the second configuration.
4. An aerosol provision system according to clause 1, wherein the aerosol outlet channel is rotatable between the first configuration and the second configuration.
5. An aerosol provision system according to any preceding clause, wherein the aerosol outlet channel comprises a first portion and a second portion, wherein the first portion is configured to move relative to the second portion as the aerosol outlet channel moves between the first configuration and the second configuration.
6. An aerosol provision system according to clause 5, wherein a greater amount of the second portion is configured to be exposed to the aerosol in the aerosol outlet channel when the aerosol outlet channel is in the second configuration than when the aerosol outlet channel is in the first configuration.
7. An aerosol provision system according to clause 5 or 6, wherein a progressively greater amount of the second portion is configured to be exposed to the aerosol in the aerosol outlet channel as the aerosol outlet channel progressively moves from the first configuration to the second configuration.
8. An aerosol provision system according to any of clauses 5-7, wherein the first portion is configured to rotate relative to the second portion as the aerosol outlet channel moves between the first configuration and the second configuration.
9. An aerosol provision system according to any of clauses 5-8 wherein the first portion is located within the second portion.
10. An aerosol provision system according to any of clauses 5-9, wherein the first portion is concentric with the second portion.
11. An aerosol provision system according to any of clauses 5-10, wherein the first portion is tubular.
12. An aerosol provision system according to any of clauses 5-11, wherein the second portion is tubular.
13. An aerosol provision system according to any of clauses 5-12, wherein the second portion comprises a material that is more thermally conductive than the material of the first portion.
14. An aerosol provision system according to any of clauses 5-13, wherein the second portion comprises at least one metal and/or the first portion comprises at least one plastic material.
15. An aerosol provision system according to any of clauses 5-14, wherein the first portion is configured to rotate relative to the second portion as the aerosol outlet channel moves between the first configuration and the second configuration.
16. An aerosol provision system according to any of clauses 5-15, wherein the first portion is configured to translate relative to the second portion as the aerosol outlet channel moves between the first configuration and the second configuration.
17. An aerosol provision system according to any of clauses 5-16, wherein the first portion is configured to not rotate relative to the second portion as the aerosol outlet channel moves between the first configuration and the second configuration.
18. An aerosol provision system according to any of clauses 5-17, wherein the first portion is configured to separate from the second portion as the aerosol outlet channel moves from the first configuration to the second configuration.
19. An aerosol provision system according to any of clauses 5-18, wherein the first portion is configured to move relative to the second portion as the aerosol outlet channel moves between the first configuration and the second configuration, such that the length of the aerosol outlet channel is configured to vary as the aerosol outlet channel moves between the first configuration and the second configuration.
20. An aerosol provision system according to any of clauses 5-19, wherein the first portion comprises a window for allowing aerosol, passing through the aerosol outlet channel, to be exposed to the second portion, through the window, when the aerosol outlet channel is in second configuration.
20. An aerosol provision system according to any preceding clause, wherein the aerosol outlet channel is tubular.
21. An aerosol provision system according to any preceding clause, wherein the aerosol outlet channel is longer in the second configuration than when the aerosol outlet channel is in the first configuration.
22. An aerosol provision system according to any preceding clause, wherein the aerosol provision system further comprises a thermally conductive portion which is configured to be more exposed to aerosol passing through the aerosol outlet channel when the aerosol outlet channel is in the second configuration than when the when the aerosol outlet channel is in the first configuration.
23. An aerosol provision system according to clause 22, wherein the thermally conductive portion comprises, or is made of, metal.
24. An aerosol provision system according to clause 22 or 23, wherein a greater surface area of the thermally conductive portion is configured to be exposed to aerosol passing through the aerosol outlet channel when the aerosol outlet channel is in the second configuration than when the aerosol outlet channel is in the first configuration.
25. An aerosol provision system according to any of clauses 22-24, when further dependent on clause 5 at least, wherein the thermally conductive portion is located between the first portion and the second portion.
26. An aerosol provision system according to any of clauses 22-25, wherein the thermally conductive portion is configured for passively cooling aerosol passing through the aerosol outlet channel when the aerosol outlet channel is in the second configuration.
27. An aerosol provision system according to clause 26, wherein the thermally conductive portion is configured for passively cooling aerosol passing through the aerosol outlet channel when the aerosol outlet channel in both the first configuration and the second configuration, wherein the thermally conductive portion is configured for passively cooling the aerosol passing through the aerosol outlet channel by a greater amount when the aerosol outlet channel is in the second configuration than when the aerosol outlet channel is in the first configuration.
28. An aerosol provision system according to any preceding clause, wherein the aerosol outlet channel comprises an internal surface area which is configured to be exposed to the aerosol passing through the aerosol outlet channel, wherein the internal surface area is configured to be larger in the second configuration of the aerosol outlet channel than when the aerosol outlet channel is in the first configuration.
29. An aerosol provision system according to any preceding clause, wherein the reservoir surrounds the aerosol outlet channel.
30. An aerosol provision system according to any preceding clause, wherein the reservoir is annular.
31. An aerosol provision system according to any preceding clause, wherein the aerosol provision system further comprises an aerosol-generating material transport element for transporting the aerosol-generating material from the reservoir to the heating element.
32. An aerosol provision system according to any preceding clause, wherein the aerosol outlet channel is configured to be moved between the first configuration and the second configuration by a user of the aerosol provision system.
33. An aerosol provision system according to any preceding clause, wherein the aerosol outlet channel is configured to be moved between the first configuration and the second configuration by a user moving the aerosol outlet channel of the aerosol provision system.
34. An aerosol provision system according to any preceding clause, wherein a user moving the aerosol outlet channel of the aerosol provision system comprises the user performing any combination of the following actions on the aerosol outlet channel:
   i) pulling the aerosol outlet channel;
   ii) pushing the aerosol outlet channel;
   iii) rotating the aerosol outlet channel;
   iv) twisting the aerosol outlet channel; and/or
   v) sliding the aerosol outlet channel.
35. A consumable for an aerosol provision system comprising the consumable and an aerosol provision device configured to receive the consumable, wherein the consumable comprises:
   a heating element for heating aerosol generating material from a reservoir to generate an aerosol in an aerosol generation region;
   an aerosol outlet channel for delivering the aerosol from the aerosol generation region to an outlet of the aerosol provision system;
   wherein the aerosol outlet channel is moveable between a first configuration and a second configuration such that a greater temperature change is configured to be effected in the aerosol, whilst the aerosol passes through the aerosol outlet channel, when the aerosol outlet channel is in the second configuration than when the aerosol outlet channel is in the first configuration.
36. A method of varying the temperature of an aerosol delivered from an aerosol provision system, the method comprising:
   generating an aerosol, from aerosol-generating material, in an aerosol generation region using a heating element which heats the aerosol-generating material;
   delivering the aerosol from the aerosol generation region, via an aerosol outlet channel, to an outlet of the aerosol provision system;
   wherein the method further comprises:
   moving the aerosol outlet channel between a first configuration and a second configuration to effect a temperature change in the aerosol, whilst the aerosol passes through the aerosol outlet channel, wherein a greater temperature change is configured to be effected in the aerosol, whilst the aerosol passes through the aerosol outlet channel, when the aerosol outlet channel is in the second configuration than when the aerosol outlet channel is in the first configuration.
37. A method according to clause 36, wherein moving the aerosol outlet channel between the first configuration and the second configuration comprises rotating the aerosol outlet channel between the first configuration and the second configuration.
38. A method according to clause 36 or 37, wherein moving the aerosol outlet channel between the first configuration and the second configuration comprises changing the length of the aerosol outlet channel.
39. A method according to clause 38, wherein the length of the aerosol outlet channel is at least 15% longer in the second configuration than when the aerosol outlet channel is in the first configuration.
40. A method according to clause 38 or 39, wherein changing the length of the aerosol outlet channel comprises telescopically changing the length of the aerosol outlet channel.
41. A method according to any of clauses 38-40, wherein changing the length of the aerosol outlet channel comprises sliding a first part of the aerosol outlet channel with respect to a second part of the aerosol outlet channel.
42. A method according to any of clauses 36-41, wherein moving the aerosol outlet channel between the first configuration and the second configuration comprises changing the profile of the aerosol outlet channel between the first configuration and the second configuration.
43. A method of varying the temperature of an aerosol passing through an aerosol outlet channel from an aerosol provision system, the method comprising:
   moving the aerosol outlet channel between a first configuration and a second configuration to effect a temperature change in the aerosol, whilst the aerosol passes through the aerosol outlet channel, wherein a greater temperature change is configured to be effected in the aerosol, whilst the aerosol passes through the aerosol outlet channel, when the aerosol outlet channel is in the second configuration than when the aerosol outlet channel is in the first configuration.

1. An aerosol provision system comprising:
a heating element for heating aerosol-generating material from a reservoir to generate an aerosol in an aerosol generation region of the aerosol provision system;
a temperature-detecting portion which is configured to generate an output based on the temperature of air surrounding, or passing into, the aerosol provision system;
wherein the aerosol provision system is configured to modify an amount of power which is delivered to the heating element, such to modify the temperature of the aerosol which is generated in the aerosol generation region, depending on a temperature of air surrounding, or passing into, the aerosol provision system, based on the output from the temperature-detecting portion;
wherein the aerosol provision system further comprises:
an air inlet channel for delivering air to the heating element;
wherein the temperature of air surrounding, or passing into, the aerosol provision system comprises the temperature of the air in the air inlet channel; and
wherein the air inlet channel comprises an orifice which is configured to deliver air from the air inlet channel to the temperature-detecting portion.

2. The aerosol provision system according to claim 1, wherein the temperature-detecting portion comprises a temperature sensor for outputting sensor data indicative of the temperature of air surrounding, or passing into, the aerosol provision system, wherein the output comprises the sensor data.

3. The aerosol provision system according to claim 1, wherein the aerosol provision system further comprises:
control circuitry configured to:
receive the output from the temperature-detecting portion; and
process the output to determine whether to modify the amount of power which is delivered to the heating element such to modify the temperature of the aerosol which is generated in the aerosol generation region.

4. The aerosol provision system according to claim 1, wherein the temperature-detecting portion is exposed to the air inside the air inlet channel.

5. The aerosol provision system according to claim 1, wherein the temperature-detecting portion is located in the air inlet channel.

6. The aerosol provision system according to claim 4, wherein the air inlet channel further comprises a plenum chamber;
wherein the plenum chamber is configured to receive air passing through the air inlet channel; and
wherein the plenum chamber is located in the air inlet channel in a position which is upstream of the heating element and which is downstream of the temperature-detecting portion.

7. The aerosol provision system according to claim 4, wherein the aerosol provision system further comprises an air inlet for delivering air into the air inlet channel.

8. The aerosol provision system according to claim 7, wherein the air inlet defines an orifice in an outer wall of the aerosol provision system.

9. The aerosol provision system according to claim 8, wherein the temperature-detecting portion is separated from the outer wall of the aerosol provision system by at least 2mm.

10. The aerosol provision system according to claim 8, wherein the temperature-detecting portion is thermally insulated, or at least partially thermally insulated, from the outer wall of the aerosol provision system.

11. The aerosol provision system according to claim 10, wherein the aerosol provision system comprises a thermally insulating material, between the temperature-detecting portion and the outer wall of the aerosol provision system, for thermally insulating, or at least partially thermally insulating, the temperature-detecting portion from the outer wall of the aerosol provision system.

12. The aerosol provision system according to claim 7, wherein there is no direct line-of-sight between the temperature-detecting portion and the air inlet.

13. The aerosol provision system according to claim 1, wherein the aerosol provision system further comprises a passage which is in fluid communication with the temperature-detecting portion, wherein the orifice is configured to allow a portion of the air from the air inlet channel to pass into the passage, and wherein the orifice is located at a first end of the passage.

14. The aerosol provision system according to claim 13, wherein the temperature-detecting portion is located in the passage, or is located at a second end of the passage which is opposite the first end.

15. The aerosol provision system according to claim 1, wherein the temperature-detecting portion is spaced from the heating element by at least 4 mm.

16. The aerosol provision system according to claim 1, wherein the temperature-detecting portion is thermally insulated, or at least partially thermally insulated, from the heating element.

17. The aerosol provision system according to claim 1, wherein there is no direct line-of-sight between the temperature-detecting portion and the heating element.

18. The aerosol provision system according to claim 1, wherein the aerosol provision system further comprises:
an outer housing, wherein the heating element and the temperature-detecting portion are located within the outer housing.

19. The aerosol provision system according to claim 18, wherein the control circuitry being configured to:
process the output to determine whether to modify the amount of power which is delivered to the heating element further comprises the control circuitry being configured to:
determine whether the output is indicative of a temperature which is less than, or equal to, a predetermined temperature; and
provide a first amount of power which is delivered to the heating element in response to determining that the output is indicative of a temperature which is less than, or equal to, the predetermined temperature; and
provide a second amount of power, which is less than the first amount of power, which is delivered to the heating element in response to determining that the output is indicative of a temperature which is greater than the predetermined temperature.

20. The aerosol provision system according to claim 19, wherein the predetermined temperature is no greater than, or equal to, 20° C.

21. The aerosol provision system according to claim 3, wherein the control circuitry being configured to:
process the output to determine whether to modify the amount of power which is delivered to the heating element further comprises the control circuitry being configured to:
determine whether the output is indicative of a temperature which is equal to, or greater than, a second predetermined temperature; and
provide the second amount of power which is delivered to the heating element in response to determining that the output is indicative of a temperature which is less than the second predetermined temperature; and
provide a third amount of power, which is less than the second amount of power, which is delivered to the heating element in response to determining that the output is indicative of a temperature which is equal to, or greater than, the second predetermined temperature.

22. The aerosol provision system according to claim 21, wherein the predetermined temperature is 30° C.

23. The aerosol provision system according to claim 19, wherein the first amount of power is between 10%-25% more than the second amount of power.

24. The aerosol provision system according to claim 19, wherein the first amount of power is greater than 5.8 W.

25. The aerosol provision system according to claim 19, wherein the second amount of power is less than 5.7 W.

26. The aerosol provision system according to claim 1, wherein the temperature-detecting portion comprises a temperature dependent switch.

27. The aerosol provision system according to claim 1, wherein the temperature-detecting portion comprises a thermistor.

28. The aerosol provision system according to claim 1, wherein the temperature-detecting portion is located on an external surface of the aerosol provision system.

29. The aerosol provision system according to claim 1, wherein the aerosol provision system further comprises a consumable and an aerosol provision device configured to receive the consumable, wherein the consumable comprises the heating element.

30. The An aerosol provision system according to claim 29, wherein the aerosol provision device comprises the temperature-detecting portion.

31. The aerosol provision system according to claim 30, wherein the temperature-detecting portion is located on an external surface of the aerosol provision device.

32. A consumable for an aerosol provision system comprising the consumable and an aerosol provision device configured to receive the consumable, wherein the consumable comprises:
a heating element for heating aerosol-generating material from a reservoir to generate an aerosol in an aerosol generation region of the aerosol provision system;
wherein the aerosol provision device comprises:
a temperature-detecting portion which is configured to generate an output based on the temperature of air surrounding, or passing into, the aerosol provision system;
wherein the aerosol provision system is configured to modify an amount of power which is delivered to the heating element, such to modify the temperature of the aerosol which is generated in the aerosol generation region, depending on a temperature of air surrounding, or passing into, the aerosol provision system, based on the output from the temperature-detecting portion;
wherein the aerosol provision device further comprises:
an air inlet channel for delivering air to the heating element;
wherein the temperature of air surrounding, or passing into, the aerosol provision device comprises the temperature of the air in the air inlet channel; and
wherein the air inlet channel comprises an orifice which is configured to deliver air from the air inlet channel to the temperature-detecting portion.

33. A method of varying the temperature of an aerosol delivered from an aerosol provision system, the method comprising:
generating an output, from a temperature-detecting portion of the aerosol provision system, which is indicative of a temperature of air surrounding, or passing into, the aerosol provision system;
the aerosol provision system using the output to determine whether to modify an amount of power which is delivered to the heating element such to modify the temperature of the aerosol which is generated in the aerosol generation region; wherein
air is delivered to the temperature-detecting portion by an air inlet channel for delivering air to the heating element, the temperature of air surrounding, or passing into, the aerosol provision system comprising the temperature of the air in the air inlet channel.

34. The method according to claim 33, wherein the aerosol provision system using the output to determine whether to modify the amount of power which is delivered to the heating element further comprises the aerosol provision system:
determining whether the output is indicative of a temperature which is less than, or equal to, a predetermined temperature; and
providing a first amount power which is delivered to the heating element in response to determining that the output is indicative of a temperature which is less than, or equal to, the predetermined temperature; and
providing a second amount power, which is less than the first amount of power, which is delivered to the heating element in response to determining that the output is indicative of a temperature which is greater than the predetermined temperature.
